(19) United States
(12) Patent Application Publication
(10) Pub. No.: US 2026/0056346 A1
(43) Pub. Date: Feb. 26, 2026

(54) Geomodelling With Respect To Subsoil Having Wells

(71) Applicant: TotalEnergies OneTech, Courbevoie (FR)

(72) Inventors: Pierre Biver, Pau Cedex (FR); Augustin Gouy, Pau Cedex (FR); Anahita Abadpour, Pau Cedex (FR)

(21) Appl. No.: 19/106,108

(22) PCT Filed: Aug. 25, 2022
(86) PCT No.: PCT/IB2022/000480

§ 371 Date: Feb. 24, 2025

(51) Int. Cl. G01V 20/00

(52) U.S. Cl. CPC G01V 20/00

(57) ABSTRACT

The disclosure notably relates to a computer-implemented method of geomodelling with respect to a subsoil having one or more wells. The method comprises providing, for at least one well, respective historical flow data. The method comprises providing a plurality of geological models each representing the subsoil. Each geological model comprises respective 3D objects each representing a respective lithology. Each 3D object is specified at least by respective positioning values. The method comprises providing a flow simulator. The method comprises providing a pairing between the 3D objects across the geological models. The method comprises performing history-matching to calibrate the plurality of geological models on the historical data based on the respective positioning values of each respective 3D object, the flow simulator and the pairing. The method forms an improved solution for geomodelling with respect to a subsoil having one or more wells.

### TECHNICAL FIELD

The disclosure relates to the field of computer programs and systems, and more specifically to a method, system and program of geomodelling with respect to a subsoil having one or more wells.

### BACKGROUND

Modeling tools are now available to improve the exploitation of subsoils. In particular, these subsoils can include production wells and the modeling tools may be based on flow (e.g. fluid production) data at these production wells. The modeling tools are generally based on a plurality of geological models each comprising a spatial distribution of variables describing the intrinsic properties of the subsoil (such as geometry, porosity or permeability). The plurality of geological models allows considering uncertainties regarding the constitution of the subsoil and to make hypotheses on its constitution. Indeed, each geological model represents a hypothetical constitution of the subsoil and considering a plurality of geological models allows to consider a plurality of hypothetical constitutions. This is particularly relevant for subsoil analysis, as it is difficult (if not impossible) to determine a single geological model representing the exact constitution of the subsoil, as this exact constitution is unknown.

Each geological model generally comprises a gridding comprising cells and cell-wise distributions of values representing the constitution of the subsoil (e.g., cell-wise distributions of porosity, permeability and/or lithology values such as facies). From these cell-wise distributions, a flow simulator can be used to simulate flow of a fluid in the subsoil, such as produced oil and/or gas or produced water. For example, the flow simulation can take as input the cell-wise distributions and output virtual flow data at the production wells. The relevance of the virtual flow data produced therefore depends on the quality with which the geological models realistically simulate the subsoil. For this reason, one of the first steps is to calibrate the plurality of geological models.

The calibration is generally performed based on a history-matching technique, that is on a technique aimed at inverting variables of the models so as to virtually recover historical flow data (thus known to be exact). These historical flow data are flow data observed at the wells during a past time interval. During the history-matching, the cell-wise distributions of the geological models are inverted so as to minimize an error between the virtual flow data outputted by the geological models and the observed historical flow data. The calibration of the plurality of geological models thus amounts to an inversion problem.

While inverting continuous parameters such as of porosity and permeability is well-known in the prior art, inverting discrete variables such as lithology (e.g., facies) remains an issue, precisely due to their discreteness. Known techniques involving using underlying gaussian fields are known as truncated gaussian methods. In these methods, the underlying gaussian fields of the variables of the geological models can be updated (e.g., with a Kalman gain matrix) and calibrated geological models can be built from these updated underlying gaussian fields. However, for discrete variables such as facies values, this method does not work well in that it yields inaccurate results. This strongly limits the application domain of the history-matching.

Within this context, there is still a need for an improved method of geomodelling with respect to a subsoil having one or more wells.

### SUMMARY

It is therefore provided a computer-implemented method of geomodelling with respect to a subsoil having one or more wells. The method comprises providing, for at least one well, respective historical flow data. The method comprises providing a plurality of geological models each representing the subsoil. Each geological model comprises a respective gridding comprising cells. Each geological model comprises a respective cell-wise distribution of porosity values and a respective cell-wise distribution of permeability values. Each geological model comprises respective 3D objects each representing a respective lithology. Each 3D object is specified at least by respective positioning values. The method comprises providing a flow simulator. The method comprises providing a pairing between the 3D objects across the geological models. The method comprises performing history-matching to calibrate the plurality of geological models on the historical data based on the respective cell-wise distribution of porosity values, the respective cell-wise distribution of permeability values, the respective positioning values of each respective 3D object, the flow simulator and the pairing.

The method may comprise one or more of the following:
the history-matching includes iteratively, for each geological model:
   determining a cell-wise distribution of lithology values based on the respective positioning values of the respective 3D objects;
   inputting to the flow simulator the cell-wise distribution of porosity values, the cell-wise distribution of permeability values, and the determined cell-wise distribution of lithology values, so as to calculate respective virtual flow data corresponding to the respective historical flow data of each of the at least one well;
   for each of the at least one well, computing a respective error between the respective virtual flow data and the respective historical flow data;
   based on the pairing and on each respective error, inverting the respective cell-wise distribution of porosity values, the respective cell-wise distribution of permeability values, and the respective positioning values of each respective 3D object;
each 3D object is specified by a respective set of backbone nodes, the respective positioning values specifying each 3D object including respective coordinates of each backbone node;
each 3D object is further specified by, for each backbone node, a respective cross-section, the set of backbone nodes and the respective cross-sections delimiting, for each 3D object, a respective volume of the 3D object, the determining of the cell-wise distribution of lithology values comprising, for each cell of the respective gridding:
   determining whether a center of the cell is inside the respective volume of one of the respective 3D objects; and
   selecting, for the cell, a first lithology value when the center of the cell is inside the respective volume, or a second lithology value when the center of the cell is not inside the respective volume;
each respective cross-section is convex and has a thickness and a width, the respective positioning values specifying each 3D object further including the thickness and the width of each respective cross-section;
the inverting is based on an ensemble Kalman filter approach based on a state vector, the state vector including the respective cell-wise distribution of porosity values, the respective cell-wise distribution of permeability values and the respective positioning values of each respective 3D object, the inverting of the respective positioning values of each respective 3D object comprising updating the state vector based on:
   a covariance matrix between the respective virtual flow data and the state vector,
   a variance matrix in the respective virtual flow data,
   an error matrix of the respective historical flow data, and
   a difference between the respective historical flow data and the respective virtual flow data;
the updating comprises performing a distance-based localization, thereby ignoring one or more 3D objects positioned at a distance greater than a threshold from each of the at least one well;
at least one first geological model of the plurality has a first number of respective 3D objects and at least one second geological model of the plurality has a second number of respective 3D objects, the first number being lower than the second number, the method further comprising adding one or more 3D objects to each of the at least one first geological model, the number of the added one or more 3D objects being equal to the difference between the second number and the first number;
a thickness of each respective cross-section of each of the added one or more 3D objects is zero;
the method further comprising, for each geological model and each well, constraining a respective 3D object to pass through the well, the pairing comprising pairing the respective 3D objects of the geological models constrained to pass through a same well,
the constraining of the respective 3D object to pass through the well comprises translating the respective 3D object towards a center of the well;
the historical production flow data is divided into clusters, and the translating of the respective 3D object comprises applying a thickness modification to the respective 3D object with thresholds dependent on sizes of clusters and a grid resolution; and/or
the backbone nodes of each constrained 3D objects are numbered, the translating of the respective 3D object comprising centering a given backbone node of the set of backbone nodes of the respective 3D object on the well, the number of the given backbone node being, for each well, the same for each respective 3D object constrained to pass through the well.

It is further provided a computer program comprising instructions for performing the method.

It is further provided a computer readable storage medium having recorded thereon the computer program. It is also provided a device comprising the computer readable storage medium. The device may form or serve as a non-transitory computer-readable medium, for example on a Saas (Software as a service) or other server, or a cloud based platform, or the like.

It is further provided a system comprising a processor coupled to a memory and a graphical user interface, the memory having recorded thereon the computer program.

### BRIEF DESCRIPTION OF THE DRAWINGS

Non-limiting examples will now be described in reference to the accompanying drawings, where:

FIGS. 1 to 5 illustrate an example of the providing of the plurality of geological models;

FIG. 6 shows a general workflow of the method;

FIG. 7 illustrates an example of the pairing of the 3D objects;

FIG. 8 illustrates an example of the constraining of the 3D objects;

FIG. 9 illustrates an example of the translating of the 3D objects;

FIGS. 10 and 11 illustrate an example of the applying of the thickness modification;

FIG. 12 shows examples of the centering of the given backbone node;

FIGS. 13 to 18 illustrate examples of results of the method;

FIGS. 19 to 22 illustrate examples of the localization; and

FIG. 23 shows an example of the system.

### DETAILED DESCRIPTION

It is therefore provided a computer-implemented method of geomodelling with respect to a subsoil having one or more wells. The method comprises providing, for at least one well, respective historical flow data. The method comprises providing a plurality of geological models each representing the subsoil. Each geological model comprises a respective gridding comprising cells. Each geological model comprises a respective cell-wise distribution of porosity values and a respective cell-wise distribution of permeability values. Each geological model comprises respective 3D objects each representing a respective lithology. Each 3D object is specified at least by respective positioning values. The method comprises providing a flow simulator. The method comprises providing a pairing between the 3D objects across the geological models. The method comprises performing history-matching to calibrate the plurality of geological models on the historical data based on the respective cell-wise distribution of porosity values, the respective cell-wise distribution of permeability values, the respective positioning values of each respective 3D object, the flow simulator and the pairing.

The method constitutes an improved method of geomodelling with respect to a subsoil having one or more wells.

Notably, the method allows efficiently and accurately performing the history-matching to calibrate the plurality of geological models. Indeed, the history-matching is no longer limited to truncated gaussian related geological models. The method allows taking into account more information (including the lithology) in the history-matching, which is an improvement over prior art methods. The use of 3D objects representing the lithology and the taking into account of their position in the history-matching allows to include the information on lithology during the calibration of the geological models.

Moreover, the inclusion of information on lithology allows obtaining calibrated geological models that are more realistic and consistent with the real subsoil they model. The calibration is accurate in that the geological models allow reproducing accurately the historical data at the well(s) and thus accurately predict future data. In particular, the 3D objects convey located lithological information and thereby allow reproducing realistic variations in the constitution of the subsoil (such as channels, for example). Each 3D object reproduces a given spatial continuity in the subsoil constitution, and the continuities created by each of the 3D objects are taken into account during calibration, which therefore improves the calibration process (particularly in terms of convergence). The method therefore improves the history-matching calibration in time and accuracy since the position values of the 3D objects are particularly relevant for determining a realistic constitution of the subsoil.

As common and known for history-matching methods based on historical flow data related to one or more wells of a subsoil, the method may comprise using the calibrated plurality of geological models to determine operation of the subsoil. For example, the subsoil may be subject to (human) production via the one or more wells (e.g., fluid production such as oil and/or gas production, or water production) and the historical flow data may represent such production by the at least one well (e.g. fluid production and/or fluid injection). The method may in such a case comprise using the calibrated plurality of geological models to adapt (e.g., in real-time) the production strategy. For example, the method may comprise predicting future flow data based on the calibrated plurality of geological models. The predicting may comprise inputting the calibrated plurality of geological models for each well into the flow simulator (e.g., with other data such as production parameters for the one or more wells) and outputting, by the flow simulator, virtual future flow data (e.g., fluid pressure, and/or, extraction rate or injection rate). The method may further comprise determining one or more subsoil operations to be performed based on the predicted future flow data (e.g., to optimize the operation of the subsoil and/or to reach a given production rate, for example under one or more production and/or material constraints).

The subsoil operation(s) may comprise adapting one or more production parameters for one or more (e.g., all) of the wells (e.g., a quantity such as a rate of extracted fluid for a production well and/or of injected fluid for an injection well, e.g. a quantity of CO2 injected in the well). For example, the subsoil operation(s) may comprise applying, for each of the one or more wells, a respective extraction or injection rate of the fluid (e.g., via a pump or liquid injection to exert pressure on the fluid in the wells). The subsoil operation(s) may also comprise drilling one or more new wells into the subsoil. For example, the method may comprise determining, for each new well, a respective location on the surface of the subsoil and/or a respective depth into the subsoil for the new well, and optionally also a respective extraction or injection rate for the new well. The subsoil operation(s) may also comprise shutting down production in one or more of the wells. For example, the subsoil operation(s) may comprise dismantling and/or closing the one or more of the wells that are shut down. The method may comprise determining any one or any combination of these subsoil operations to be performed in the subsoil. After the determining of the subsoil operations to be performed, the method may comprise performing, in the real world, the determined subsoil operations in the subsoil.

The providing steps of the method are now discussed.

The provided respective historical flow data may include various types of observation data at the one or more wells. The historical flow data may comprise fluid production data and/or fluid injection data. For example, the respective historical flow data may include pressure data (e.g., a bottom hole pressure “BHP”), production rate data (e.g., an oil production rate “ORP” or a water production rate “WRP”) or water cut data (“WCT”). Alternatively or additionally, the respective historical flow data may include a concentration of a chemical species through time (e.g., obtained via a tracer test and/or a pollution monitoring). The historical flow data are real flow data. The subsoil is a real-world subsoil and the well(s) are real-world well(s). The historical flow data may have been collected in the real-world subsoil and well(s) (e.g., by a direct measurement or by calculating them from direct measurements at each well). The measurements of the historical flow data may have already been performed prior to the performing of the method. For example, the measured historical flow data may have been stored on a computer storage medium (for example, a memory or a server). The provision of the historical flow data may comprise retrieving the historical flow data from the computer storage medium.

The one or more wells may comprise several wells of different types. For example, the one or more wells may comprise at least one injection well and/or at least one production well. The respective historical flow data may depend on the type of the well. For example, for a production well, the respective historical flow data of the production well may include the oil or water production rate. The historical flow data may include an evolution in time of the flow data. For example, each historical flow data may include, at regular time intervals (e.g. daily, monthly or yearly), an evolution of the flow data (e.g., fluid production data and/or fluid injection data) over a period of time (e.g. over several weeks or years).

Each of the geological models comprises a respective gridding comprising cells, a respective cell-wise distribution of porosity values and a respective cell-wise distribution of permeability values and respective 3D objects. In examples, the geological models may each comprise the same gridding. For example, the number and/or size of cells in the gridding may be the same for each geological model. Each cell may represent a respective portion of the subsoil. Alternatively, the gridding of one of the geological models may differ from the gridding of another one of the geological models. The gridding represents a geometrical subdivision of the subsoil into a set of spatially ordered portions and each cell represents a respective portion of this set. The cells may have substantially the same size and substantially the same geometric shape. For example, the cells may be substantially parallelepiped in shape and the gridding may be regular. Alternatively, the cells may be different in shape and/or size. For example, the dimensions and/or positions of the cells may be adapted according to the constitution of the subsoil. For example, the arrangement of the cells may be adapted to follow the shape of a particular soil constitution or a fault.

The respective cell-wise distribution of porosity values may include, for each cell of the gridding, a respective porosity value. The respective porosity value represents value of porosity in the respective portion of the subsoil that the cell represents, for example an average porosity of said portion. Similarly, the respective cell-wise distribution of permeability values may include, for each cell of the gridding, a respective permeability value, which represents value of permeability in the respective portion of the subsoil that the cell represents (e.g., an average permeability of said portion). The respective distribution per cell of the porosity values and the respective distribution per cell of the permeability values may (in whole or in part) correspond to actual measured values on the subsoil. For example, the method may comprise, for each geological model, determining the respective distribution per cell of the porosity values and the respective distribution per cell of the permeability values based on measured porosity and permeability data.

Each geological model comprises 3D objects. The 3D objects are representatives of lithologies. These lithologies are discrete variables with potentially discrete data. One of the lithologies may be associated with a soil matrix. The lithology associated with the soil matrix may be not very permeable and/or not very porous. The lithology associated with the soil matrix may serve as a background lithology for the objects. Each of these lithologies may be associated with a soil type. Each 3D object represents a given portion of the subsoil having the lithology represented by the 3D object. The 3D objects thus represents lithology information for the geological model. The method uses the 3D objects to impact the output of the flow simulator according to this lithology information. In particular, the positioning values of the 3D objects are included in the performing of the history-matching, which implies that the positions of the 3D objects are modified in the calibrated geological models (with respect to the geological models prior to the performing of the history-matching). The modification of the positions of the 3D objects induces a modification of the lithology information, and this lithology information is therefore taken into account in the calibration. For example, for each geological model, the positions of the 3D objects may define a cell-wise distribution of lithology values, and this cell-wise distribution of lithology values may be inputted to the flow simulator (which as known per se may run according to this cell-wise distribution of lithology values).

Each geological model may comprise the same number of respective 3D objects. Each geological model may comprise from one to a large number (several hundreds) of 3D objects (e.g., more than a hundred 3D objects). The respective positioning values are values determining the position of each 3D object in the geological model. For example, each 3D object may comprise several points and the positioning values may include the coordinate values of each point of the 3D object. The coordinates may be Cartesian, cylindrical, or spherical coordinates and may be defined relative to the geological model (e.g., from a coordinate system in the geological model). The method may comprise positioning the 3D objects in each of the geological models. For example, the method may comprise positioning the 3D objects differently in each of the geological models (e.g., the positioning may be totally random, or partially random).

The flow simulator may be any flow simulator (e.g., any known flow simulator used in the industry, such as Intersect, Eclipse, Nexus or ModFlow) configured to take as inputs, for a given geological model, the cell-wise distribution of porosity values, the cell-wise distribution of permeability values and a cell-wise distribution of lithology values (e.g., defined according to the positions of the 3D objects in the given geological model). The lithology values are discrete values. For example, the lithology values may be Environments of Deposition (EoD)/facies/rock types values, among a predetermined set of Environments of Deposition/facies/rock types values. The lithology values may include a permeability and/or a porosity value. For examples, the numerical data representing the 3D objects may be linked to (i.e., digitally associated to) numerical data representing a lithology of the subsoil at locations corresponding to the geometry defined by the 3D objects, and allowing to populate a geometrically corresponding cell of the gridding with a facies value, among a predetermined set of different facies. This may be implemented in any manner. For example, the 3D objects may each be associated with a respective facies value (thus constant over the whole geometry represented by the 3D object, and with at least two different facies values carried by the plurality of geological models). In such a case, such constant facies value may be assigned to all the cells corresponding in location to the 3D object, when determining the cell-wise distribution of lithology values over the gridding. In other examples, the 3D objections may carry more complex lithology information, so as to enable assigning different facies values to the cells corresponding in location to the 3D object. Facies values may be assigned in any manner to other cells (i.e., cells not corresponding in location to a 3D object), for example using a default value.

The flow simulator may also be configured to take as inputs one or more exploitation parameters. The flow simulator may be configured to calculate, from the inputs, virtual production historical data corresponding to the respective historical flow data of each of the at least one well. The calculation of historical virtual flow data may, as commonly known in the industry, be based on mathematical equations describing the behavior (mechanical and/or fluidic) of the subsoil and/or fluids (e.g., water or oil) it may contain (e.g., equations of fluid and/or solid dynamics).

The pairing may comprise sets of 3D objects across the geological models (the 3D objects belonging to a same set being paired). The pairing may be a partitioning of the 3D objects of all of the geological models in the sets of objects. Each set may comprise, for each geological model, a respective 3D object of the geological model. The number of 3D objects per set may thus be equal to the number of geological models. For each geological model, each 3D object of the geological model may be included in a respective one of the sets. The pairing may be according to the positions of the 3D objects in the geological models. For example, for at least one set, the 3D objects belonging to the set may be positioned around a substantially same point (e.g., a well) in the respective model to which they each belong.

The history-matching is now discussed.

The performing of the history-matching may comprise, for each geological model, inverting the positioning values of one or more (e.g., all) of the 3D objects that the geological model comprises. Inverting the positioning values means that the method comprises modifying said positioning values so as to reduce an error between the respective virtual flow data and the respective historical flow data. The inverting may thus comprise modifying the 3D objects in the geological models (the inverted positioning values are new positioning values for the 3D objects). After the calibration, the plurality of geological models allows reproducing the behavior of the subsoil and allow retrieving the flow data. The calibrated plurality of geological models may therefore accurately predict future flow data. In particular, the prediction statistics provided by the plurality of geological models (each of which represents a hypothesis of the constitution of the subsoil) is improved because each geological model is individually more accurate. The performing of the history-matching may be performed iteratively. For example, the performing of the history-matching may comprise, at each iteration, inverting the positioning values of the 3D objects of each geological model (i.e., calculating and attributing new positioning values to the 3D objects) such that an error between virtual flow data and the historical flow data is reduced at each iteration. The virtual flow data corresponding to the flow data simulated when the geological models with the new positioning values of the 3D objects are inputted to the flow simulator. The performing of the history-matching may be performed iteratively until a convergence criterion is fulfilled, i.e., until the error is not significantly reduced between successive iterations, or until the error is below a threshold.

The history-matching may include iteratively, for each geological model, performing the following steps. A first step may comprise determining a cell-wise distribution of lithology values based on the respective positioning values of the respective 3D objects. The distribution may be over the geological model. For example, each 3D object may delimit a respective volume of the geological model. In that case, the determining may comprise, for each 3D object, attributing a first lithology value to the cells inside the respective volume of the 3D object. The determining may then comprise attributing a second lithology value to the remaining cells (i.e., the cells that do not have an attributed first lithology value). For each iteration (after the first iteration), the positioning values of the 3D objects considered are the positioning values of the 3D objects as inverted in the previous iteration. The cell-wise distribution of lithology values is thus determined according to the positioning values as inverted in the previous iteration. For each iteration, the new positioning values of the objects are considered.

A second step may comprise inputting to the flow simulator the cell-wise distribution of porosity values, the cell-wise distribution of permeability values and the determined cell-wise distribution of lithology values, so as to calculate respective virtual flow data corresponding to the respective historical flow data of each of the at least one well. The inputting may be performed automatically. For example, the history-matching may, after the second step, automatically input the cell-wise distribution of porosity values, the cell-wise distribution of permeability values and the determined cell-wise distribution of lithology values to the simulator. The calculation is thus performed according to the positioning values of the 3D object at the current iteration (since the cell-wise distribution of lithology values is determined according to them). For each iteration (after the first iteration), the cell-wise distribution of porosity values and the cell-wise distribution of permeability values inputted to the flow simulator are the cell-wise distribution of porosity values and the cell-wise distribution of permeability values as inverted in the previous iteration. The flow simulator calculates the virtual flow data based on the inputted distributions. The calculation may be based on a simulation of the geological model. The simulation may consider a time evolution of flow data in each well (e.g., an extraction or injection rate).

A third step may comprise, for each of the at least one well, computing a respective error between the respective virtual flow data and the respective historical flow data. For example, each virtual flow data may correspond a respective historical flow data. The computing of the error may comprise computing, for each virtual flow data, a difference between the virtual flow data and the corresponding historical flow data. The computing of the error may then comprise computing the error based on the computed differences. The computed error may comprise a distribution of error values over the geological model (e.g., including a respective error value for each well).

A fourth step may comprise, based on the pairing and on each respective error, inverting the respective cell-wise distribution of porosity values, the respective cell-wise distribution of permeability values, and the respective positioning values of each respective 3D object. The inverting may consider a distribution of error values and the pairing. For example, the inverting may comprise modifying the distributions of porosity and permeability values and the positioning values at the locations in the geological model where the error is maximum. The inverting may be based on the errors computed for all the geological models. The modifying of the distributions of porosity and permeability values and the positioning values for a given geological model may consider the respective error computed for each of the other geological. For example, the modifying of the distributions of porosity and permeability values and the positioning values may comprise modifying the distributions of porosity and permeability values and the positioning values at the locations (e.g., the locations of the wells) of the geological model with the largest errors based on the distributions of other geological models having the smallest errors for these locations.

The inverting may be based on an ensemble Kalman filter approach (referred to in the following as “EnKF”). The ensemble Kalman filter approach may be based on a state vector. The state vector may include the respective cell-wise distribution of porosity values, the respective cell-wise distribution of permeability values and the respective positioning values of each respective 3D object. The inverting of the respective positioning values of each respective 3D object may comprise updating the state vector based on a covariance matrix between the respective virtual flow data and the state vector, a variance matrix in the respective virtual flow data, an error matrix of the respective historical flow data and a difference between the respective historical flow data and the respective virtual flow data.

The ensemble Kalman filter approach (“EnKF”) is a data assimilation method to improve (update) a state vector in an inverse problem setting by taking into account the correlation between model parameters and the predictions issued form these parameters as well as the difference between the model prediction and real field observations. EnKF may be based on the following equation:

$${ψ}^{a} = {ψ}^{f} + {( {C}_{ψ ψ}^{e} )}^{f} {{M}^{T} [ {M ( {C}_{ψ ψ}^{e} )}^{f} {M}^{T} + {C}_{ε ε}^{e} ]}^{- 1} ( d - M {ψ}^{f} )$$

wherein ψ^{f} and ψ^{a} are the state vector before and after the update,

$${( {C}_{ψ ψ}^{e} )}^{f} {M}^{T}$$

is the covariance matrix between model predictions and state vector,

$${M ( {C}_{ψ ψ}^{e} )}^{f} {M}^{T}$$

is the variance in the prediction of model and

$${C}_{ε ε}^{e}$$

is the error associated to the measurements (i.e., the difference between the respective historical flow data and the respective virtual flow data).

In a reservoir simulation setting, EnKF may work by representing the uncertain part of a reservoir model as a state vector where each element represents a model parameter. The model parameter may be an uncertain parameter such as permeability in a particular grid cell or facies type, the water oil contact, or the multiplier across a fault. Thus, for large reservoir models, the state vector may be of very large dimension (e.g., couple of tens of millions typically).

Measurable quantities may be associated to the state vector. The measurable quantities may be from the field (e.g., the water cut or the bottom hole pressure at the wells). The performing of the EnKF may comprise introducing the measurement errors. Then, the data assimilation technique may modify the state vectors to decrease the difference between the observed data (i.e., the historical flow data) and the simulated model responses (i.e., the virtual flow data, using the previously presented equation.

Examples of implementation for the respective 3D objects are now discussed.

Each 3D object may be specified by a respective set of backbone nodes. The backbone nodes of the 3D object may be distributed to form a line in the geological model. The backbone nodes may be numbered along the line, which may start with a first backbone node and end with a last backbone node, and with the other backbone nodes substantially regularly distributed between the first backbone node and the last backbone node. The line formed by the 3D object may be substantially horizontal (e.g., at least partially included in a plane horizontal relative to the geological model). The backbone nodes may be connected according to the line. Each backbone node may be connected with two other backbone nodes (except the first and last backbone nodes which may be connected to one single backbone node).

Each of the backbone nodes may be located at a respective location in the geological model. The geological model may comprise a coordinate system (e.g., an orthogonal system having an axis for each of the X, Y, Z directions). Each backbone node may comprise respective coordinates in the coordinate system (e.g., one for each axis of the coordinate system). The respective coordinates may define the location of the backbone node in the geological model. The respective positioning values specifies each 3D object may include the respective coordinates of each backbone node.

Each 3D object may further be specified by, for each backbone node, a respective cross-section. The cross-section may be perpendicular to a plane horizontal relative to the geological model. The cross-section may also be perpendicular to the line formed by the 3D object. For example, the cross-section may also be perpendicular to, at the location of the backbone node, a direction of the line formed by the 3D object. The set of backbone nodes and the respective cross-sections may delimit a volume of the 3D object. For example, the volume may be obtained by interpolating, along the line formed by the 3D object, the cross-sections of consecutive backbone nodes of the line. The interpolating may consider an average of the cross-sections between consecutive nodes of the line.

The determining of the cell-wise distribution of lithology values may comprise, for each cell of the respective gridding, determining whether a center of the cell is inside the respective volume of one of the respective 3D objects and selecting for the cell a first lithology value when the center of the cell is inside the respective volume or a second lithology value when the center of the cell is not inside the respective volume. The first lithology value may correspond to lithology found in a channel (e.g., sand or silt). The second lithology may correspond to lithology that is not found in a channel (e.g., a background non reservoir lithology). Objects may optionally be composed of several facies. The determining of whether the center of the cell is inside the volume may consider a boundary of the volume. The boundary may delineate the interior of the volume and the rest of the geological model. When the center is on the boundary, the determining may consider that the center is inside the volume, or alternatively may consider that the center is not inside the volume.

Each cross-section may be convex. Each cross-section may have a thickness and a width. The thickness may correspond to the length of the cross-section along a direction vertical with respect to the geological model (e.g., a direction passing through the middle of the cross-section). The width may correspond to the length of the cross-section along a direction horizontal with respect to the geological model (e.g., wherein a direction passing through where the width is maximum). The respective positioning values specifying each 3D object may further include, in addition to the positioning values, the thickness and the width of each respective cross-section. The convex shape of the cross-sections allows the 3D object to be expanded or contracted by the new values of the simulation during the history-matching. The convex shape also improves the determining of whether the center of a cell is inside or outside the volume.

An example of implementation of the method is now described.

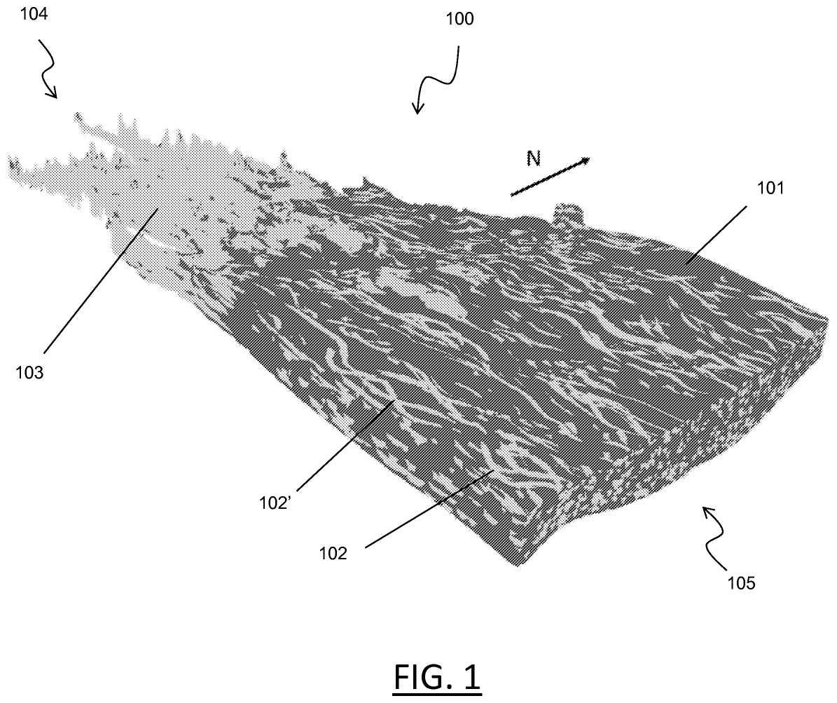

With reference to FIGS. 1 to 5, the providing of the plurality of geological models is now discussed.

The providing of the plurality of geological models may comprise generating the plurality of geological models. The generating may be based on the Boolean process method using flexible elementary objects (referred to as “FlexBoolX or FBX”), which is an object method generating discrete geological models in facies. The generating of the geological models may comprise determining parameters of geological models.

The determining of these parameters may be based on a model of a real-world subsoil. In this example, the real-world subsoil is the Roussillon aquifer in the department of Pyrenees-Orientales in southwestern France. The model (referred to as “Roussillon model”) is illustrated in FIG. 1 and may have been created prior to the preforming of the method. The aquifer, of very large extension (around 3000 km²), is modeled from three different lithologies (or facies): flood plain 101, alluvial channel 102, 102′ and alluvial fan 103. The model presents a proximal pole 104, at the Pyrenees, with a high density of alluvial fans 103, and a distal pole 105, at the Mediterranean coast, with a high density of alluvial channels 102, 102′ and flood plain 101. A slope exists between the proximal pole 104 and distal pole 105 (E-SE orientation). The grid in which the model has been created may follow the slope of the layers: its coordinates may be stratigraphic. The cells of the grid may have dimensions around 100 [m]×100 [m]×5 [m]. These dimensions vary slightly with the erosion affecting certain cells or their local dip.

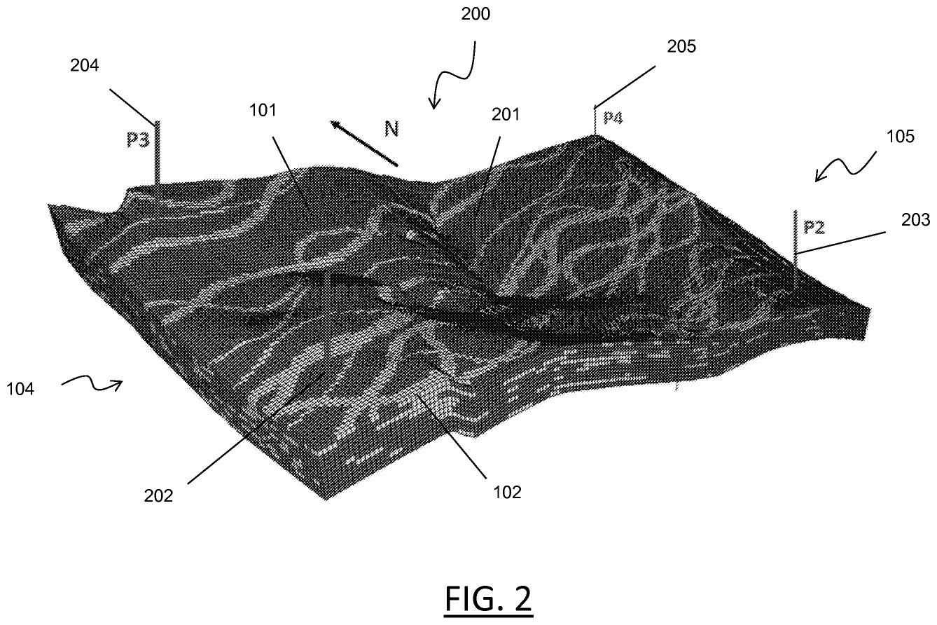

The generating may comprise creating a synthetic model from this model of the real-world subsoil in order to simplify the inversion process. FIG. 2 shows the synthetic model 200 created from the Roussillon model of the real-world subsoil of FIG. 1. The creating of the synthetic model may comprise simplifying and limiting the size of the model. In this example, the model is limited to an area around the city of Perpignan (in the center of the Roussillon plain). This area may have been selected. The creating of the synthetic model may further comprise selected a number of layers of the model to kept (e.g., only the last ten layers of the model as in this example). In other examples, another area (e.g., all the model) may be selected and another number of layers (e.g., all the layer) may be kept. The synthetic model used is this example has a size of 200×100×10 cells. The depth of the aquifer varies between +60 and −320 meters NGF. The creating of the synthetic model may further comprise simplify the model by removing the alluvial cone facies 103. This simplification only leaves two different facies: alluvial channels 102, 102′ and flood plain 101. The wells of the model comprise an injector well 201 and four producer wells 202, 203, 204 and 205. The injector well 201 is fixed in the center of the domain and the four producer wells 202, 203, 204 and 205 are fixed on the corners of the domain. At least one channel 206 passes through each well.

The generating may comprise extracting spatial trends and average values of certain properties (facies proportions, geometric properties) from the initial Roussillon model. The generating may comprise reusing these extracted spatial trends and average values as input parameters to the FlexBoolX (FBX) method previously discussed to constrain the generation of the models.

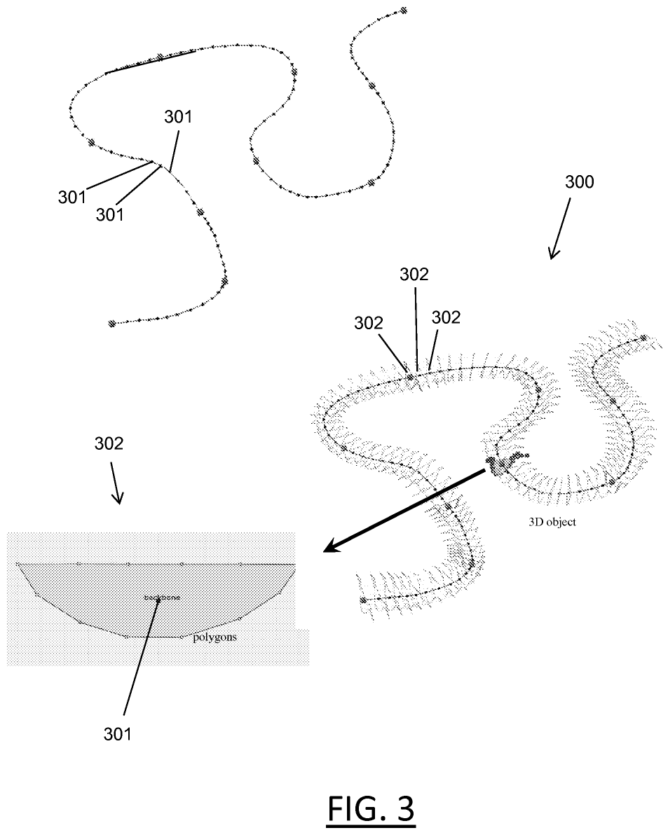

The generating may comprise, for each geological model, generating the 3D objects of the geological model. The generating of the 3D objects may comprise defining the 3D objects in space by inputting several geometric parameters for the 3D objects. These parameters may be inputted to the FBX method, which may automatically output the geological models with the 3D objects. The inputted parameters may be constant or variable in space. The inputted parameters may include parameters defining the cross-sections of the 3D objects (e.g., cross-sectional shape, length, width, thickness, azimuth, wavelength, amplitude and curvature). FIG. 3 illustrates an example of 3D object 300. The 3D object 300 is specified by a respective set of backbone nodes 301. The positioning values specifying the 3D object include the coordinates of each backbone node 301. The 3D object 300 is further specified by, for each backbone node 301, a respective cross-section 302. The set of backbone nodes 301 and the respective cross-sections 302 delimit, for each 3D object, a respective volume of the 3D object 300. In this example, the parameters of the cross-sections 302 are spatially constant, with the value chosen corresponding to the average value of the property on the initial Roussillon model. At the center of each cross-section 302, the 3D object 300 comprises a backbone node 301. The determining of the cell-wise distribution may comprise remeshing the 3D object 300 in a grid from the coordinates and geometric properties of the backbone nodes 301.

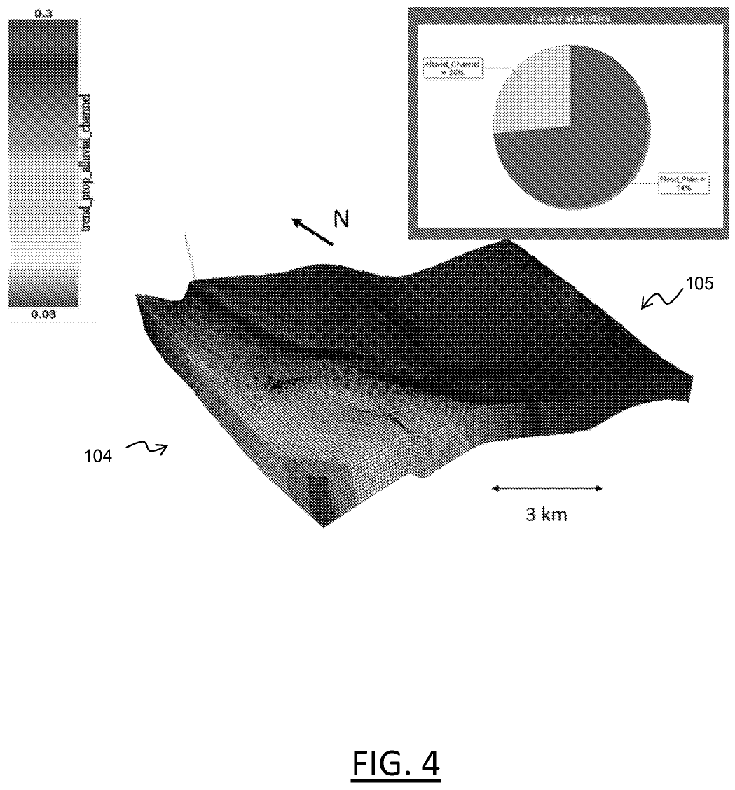

The generating of the 3D objects may further comprise constraining the proportion of 3D objects on the geological model based on the proportion existing on the initial Roussillon model. FIG. 4 illustrates the proportion of channel facies in the Roussillon model and average proportion on the grid. This presents a heterogeneity between the proximal pole 104 where the proportion of channels is low and the distal pole 105 where it is high. The average proportion of channels in the whole model is about 26%, the rest being filled by the flood plain.

The generating of the 3D objects may further comprise defining simulation parameters of the FBX method. For example, the defining of the simulation parameters may comprise setting a minimum replacement ratio between the 3D objects of an initialization phase and a simulation phase to 0.5. The defining of the simulation parameters may comprise fixing conditional data at the five wells of the model and on the ten layers of the model. Table 1 below summarizes properties of the different wells in the study area. The position (X,Y) of the well, the altitude, the number of channels crossing the well and the numbers of the layers where the channels pass (on the ten layers of the model). A percentage of conditional raster data not respected is fixed at 0% (all conditional data must be perfectly respected during the FBX simulation including the raster facies data, in our case the floodplain).

TABLE 1

| | | | Altitude | Number of | No layer |
|---|---|---|---|---|---|
| Name | X | Y | (mNGF) | channels | channels |
| P1 | 15 | 15 | 55.22 | 3 | 3: 6; 8 |
| P2 | 185 | 15 | −154.56 | 1 | 2 |
| P3 | 15 | 85 | 49.89 | 2 | 4; 5 |
| P4 | 185 | 85 | −216.05 | 3 | 1; 3; 9 |
| I1 | 100 | 50 | −105.81 | 5 | 3; 5; 6; 8; 10 |

In this example, 101 geological models are generated with this set of parameters, each with a different random seed. The channels being of constant length, and the backbone nodes of each 3D object being equidistant, the number of backbone nodes in each 3D object is constant (in this example equal to 601). Then, the generating may comprise checking the consistency of the generated geological models by re-importing them on a software (e.g., Sismage-CIG). After the checking, these geological models are processed to pair the 3D objects of the different geological models to each other.

During the history-matching, the parameters updated by the method include the X, Y and Z coordinates of the backbone nodes. Thus, during the iterations of the history-matching, the backbones are progressively moved to improve the matching of the geological models to the observation data (the historical flow data).

Each geological model has exactly the same number of parameters. Thus, each geological model may have the same number of 3D objects (since each 3D object already has the same number of backbone nodes). Having exactly the same number of parameters in each geological model improves the inversion. The total number of parameters for each model in the problem presented here is given by the following formula:

$${N}_{paramètres} = 3 \times {N}_{objets} \times {N}_{noeuds}$$

The FBX method may not allow to constrain the generated geological models to have the same number of 3D objects. Thus, at least one geological model of the plurality may have a first number of respective 3D objects and another geological model of the plurality may have a second number of respective 3D objects (e.g., the first number being lower than the second number). The problem of the pairing of 3D objects from different geological models is therefore twofold: to find for each parameter its equivalent in each geological model and to increase the number of 3D objects of the geological models which have not enough objects. For example, the method may further comprise adding one or more 3D objects to each of the at least one geological model and the number of the added one or more 3D objects may be equal to the difference between the second number and the first number.

The normalized Euclidean distance between each object of the pivot model and each object of the other models is computed. This normalized distance may be computed for a model k by the following formula:

$$d = {\sum }_{i = 1}^{{Nb}_{noeuds}} \sqrt{{( \frac{{x}_{min}^{i} - {x}_{k}^{i}}{{δ}_{x} {n}_{x}} )}^{2} + {( \frac{{y}_{min}^{i} - {y}_{k}^{i}}{{δ}_{y} {n}_{y}} )}^{2} + {( \frac{{z}_{min}^{i} - {z}_{k}^{i}}{{δ}_{z} {n}_{z}} )}^{2}}$$

wherein

$${x}_{min}^{i} , {y}_{min}^{i} and {z}_{min}^{i}$$

are the coordinates of node i of the model object Rₘᵢₙ,

$${x}_{k}^{i} , {y}_{k}^{i} and {z}_{k}^{i}$$

are the coordinates of node i of the model object k, δₓ, δ_{y} and δ_{z} are the dimensions of the cells in each direction, and nₓ, n_{y} and n_{z} the number of cells in each direction.

By computing d for each pair of objects, and assuming that there are Nₘᵢₙ objects in the Rₘᵢₙ model and Nₖ objects in the model k (Nₘᵢₙ≤Nₖ), the distances are placed in a matrix Aₖ of size Nₘᵢₙ×Nₖ. The pairing then amounts to finding a minimum sum of elements (i,j) in the matrix with unique i and j (only one element per row and column). In a linear optimization formulation, the pairing translates into:

$$\{ \begin{matrix}minimizing J = {\sum }_{1 < i < {N}_{min} , 1 < j < {N}_{k}} {d}_{ij} {x}_{ij} \\ such that {\sum }_{1 < j < {N}_{k}} {x}_{ij} = 1 ∀ i ∈ [ 1 , {N}_{min} ] \\ and {\sum }_{1 < i < {N}_{min}} {x}_{ij} = 1 ∀ j ∈ [ 1 , {N}_{k} ]\end{matrix}$$

wherein xᵢⱼ=1 when object i is paired with object j and xᵢⱼ=0 otherwise.

This so-called “assignment problem” can be solved by known algorithms (such as the Hungarian algorithm or the Munkres algorithm), with a maximum total complexity of O(n⁴) with n the size of the matrix in the case of a square matrix which is faster than listing all possibilities (complexity of O(n!)) as early as n=7). Because the matrix on which the method applies the algorithm is not square, the method only finds Nₘᵢₙ pairs of objects, so there is Nₖ−Nₘᵢₙ unpaired objects for the model k. In example, the 3D objects passing through conditional data (e.g., the wells) are chosen to be identical in all the geological models. Once the objects are paired, the method may comprise remeshing the geological models in the grid.

After the remeshing of the geological models, the method may comprise translating the geological models into a format readable by the flow simulator. An example of properties of each facies is summarized in the table below:

TABLE 2

| | | Permeability | Permeability |
|---|---|---|---|
| | | in X/Y | in Z |
| | Porosity | (mD) | (mD) |
| Channel | 0.26 | 5000 | 500 |
| Flood plain | 0.1 | 10 | 1 |

The method may comprise performing a first simulation for the ensemble of geological models with the flow simulator (e.g., a known simulator such as Intersect). The method may comprise defining the parameters of this simulation. In this example, the parameters are the following. The simulation lasts 51 years (historical part). The water injection rate in the injection well “I1” (201) is set constant at 60,000 m3/day, with a downhole pressure constraint of 500 bar (if this pressure is exceeded, the injection rate decreases). The oil production rate in the production wells “P1”, “P2”, “P3” and “P4” (202, 203, 204, 205) is set constant at 7500 m3/day/well, with a bottomhole pressure constraint of 10 bars (this corresponds to a minimum pressure). The reservoir does not contain any gas. An aquifer is present under the oil reservoir with an oil-water interface at z=280 m, i.e. at the very bottom of the field, and close to “P4”. Relative permeability curves are defined for each phase and for each facies, as well as a dead oil model for the oil including density, dynamic viscosity, formation volume factor (FVF), compressibility and bubble point pressure.

Results of this first simulation are now discussed using a post-processing process. The post-processing process studies the evolution of the following results:
BHP (bottom hole pressure) studied for the injector well and the producing wells.
OPR (oil production rate) studied for the producing wells.
WIR (water injection rate) studied for the injector well.
WCT (water cut, i.e. the ratio between the volume of water produced and the total volume of liquids produced in the production wells) studied for the producing wells.

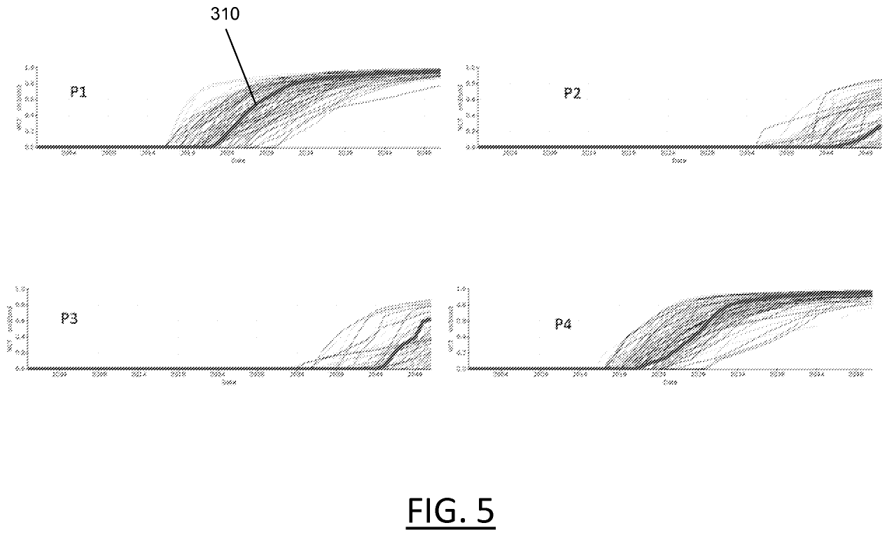

The post-processing process selects a model for which the evolution of these parameters is close to the median of the results for a majority of parameters. FIG. 5 illustrates this selecting for one of the parameters: WCT. FIG. 5 illustrates the evolution of WCT for the four wells and for all the models. The observation data are based on the BHP, OPR and WCT. The BHP, OPR and WCT are the reference data to calibrate. The BHP, OPR and WCT are issued from measurements or from a simulated reference model.

After the performing of the first simulation, the method may comprise updating the position (X,Y,Z) of the backbone nodes and remeshing them in the grid at each iteration. Moreover, the truncation c on the singular value decomposition of the Kalman gain matrix to be inverted C is taken equal to 90%, which corresponds in the studied problem to about 20% of the eigenvalues.

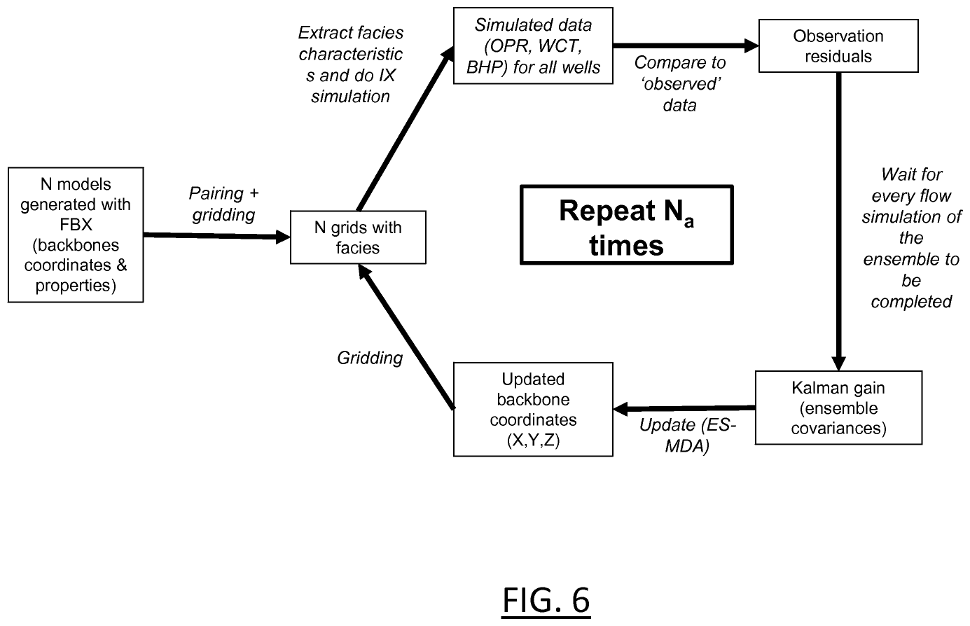

A general workflow of the method is presented in FIG. 6. As shown in this figure, the first step of the method is to generate the set of geological models with FBX (as already previously discussed). The output of this step is the coordinates (X, Y and Z) of the backbone nodes of the 3D objects created in each geological model as well as their intrinsic properties (relative position, width, thickness and curvature). This step is performed from a routine called from a known code (e.g., the MATLAB code in this example). The second step is to place the 3D objects in the grids, which is done with a second routine called, e.g. from the same MATLAB code, as well as to pair the 3D objects of the geological models between them. It is then possible to translate the grids into a format readable by the flow simulator (e.g., the known simulator Intersect) and to launch a dynamic simulation. The method may comprise retrieving dynamic output parameters and comparing them to the noisy observation data. This allows to compute the approximate Kalman gain matrix from each geological model, which allows to update the coordinates of the backbones. Finally, the backbones are placed back into the grid, and the same steps are repeated Nₐ times.

The pairing between the 3D objects across the geological models is now discussed. R₁ is referred to as the model with the most objects, R₂ the second model with the most objects and Rₖ the k-th model with the most objects, having Nₖ objects (this nomenclature amounts to sorting the models according to their decreasing number of objects).

In examples, the models are paired closely: R₁ is matched with R₂, then R₂ with R₃ and so on. One advantage of pairing in this nearest neighbor algorithm is that the sets of paired objects are maximized in size. The matching of the model Rx with the model Rₖ₊₁ comprises pairing the objects of Rₖ with the objects of Rₖ₊₁. The pairing is done from close to close (i.e. each object of Rₖ₊₁ is paired with the object of Rₖ which has the closest position to the object of Rₖ₊₁). Additionally, when the model Rₖ is matched with Rₖ₊₁, with Nₖ>Nₖ₊₁, a number Nₖ−Nₖ₊₁ of objects of Rₖ are not paired. Thus, in order to introduce the backbone variables (X,Y,Z) into the inversion process, all models may have the same number of objects. The method may therefore comprise copying the unpaired objects of Rₖ into Rₖ₊₁ (i.e., adding one or more 3D objects into Rₖ₊₁). The copying of the unpaired objects of Rx may comprise adding a new object at the same position in the next model Rₖ₊₁

In examples, the thickness of each respective cross-section of each of the added one or more 3D objects is zero. These objects may be referred to in the following as “ghost” objects. Thus, the initial proportion is always respected. The addition of “ghost” objects allows having the same number of objects in each geological models of the plurality and thus improving the pairing. In order to be able to use these objects during the inversion process, a fourth variable may be added to the problem: the thickness. Then, the method may comprise ensuring that all the objects are paired to the same object.

One property may arise from the addition of this variable: if the thickness is added as is as a variable to be updated by the history-matching, it is highly non-Gaussian and may therefore be difficult to converge. To facilitate the inversion of the thicknesses, the method may reintroduce into the problem the natural geological variability on the thickness of the objects. The initial distribution chosen for the thickness of the objects is a uniform variability between 5 m and 10 m with an average of 7.5 m. The width of the objects is also adapted in order to preserve a constant aspect ratio (ratio of width to thickness). This limits the non-Gaussian character of the variable to be updated. On the other hand, by generating objects that are sometimes small (close to five meters in thickness), the method may lose continuity in the grid (resolution effect). To limit this effect, the method may multiply the resolution of the grid in z by two for this example, going from 10 layers to 20.

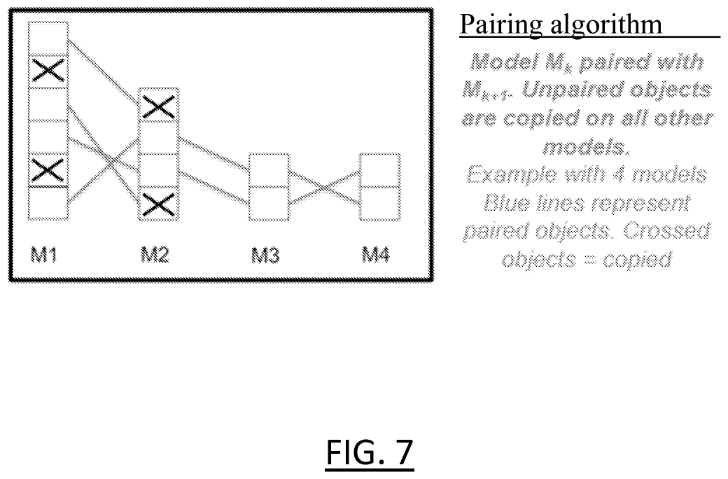

FIG. 7 shows an example of the pairing of the 3D objects. All models may have the same number of 3D objects. The constrained objects may be the same in all models. This figure shows an example of four models with six objects (M₁), four objects (M₂) and two objects (M₃ and M₄=Mₘᵢₙ). In this example, the models are paired from close to close by decreasing order of number of objects (M₁ with M₂, M₂ with M₃, etc.). All unpaired objects (black crosses) are copied into the other models. This ensures that all the objects are paired.

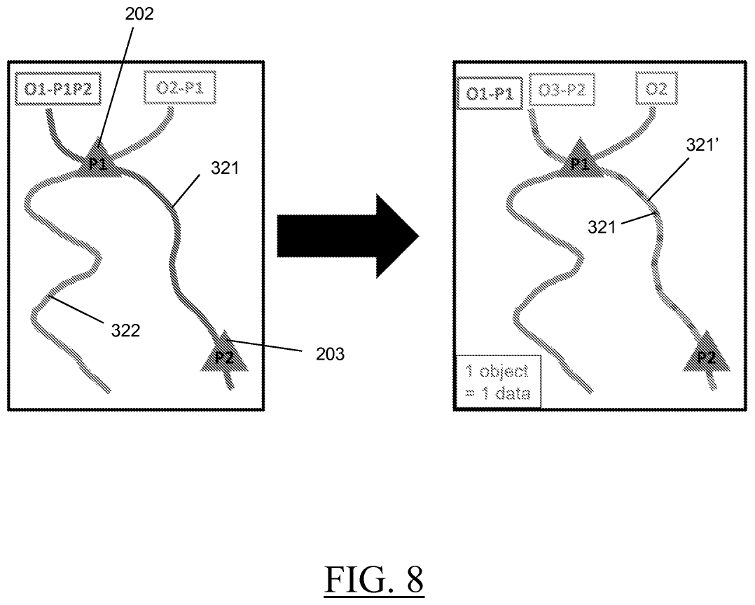

With reference to FIG. 8, the constraining of the 3D objects is now discussed in more detail. The constrained objects are the 3D objects constrained by the method to pass through one of the well(s). The method may comprise, for each geological model and each well, constraining a respective 3D object to pass through the well. The pairing may comprise pairing the respective 3D objects of the geological models constrained to pass through a same well. For example, the one or more wells may comprise several wells. At least one of the respective 3D objects may pass through at least two wells. In that case, the method may further comprise duplicating the at least one of the respective 3D object such that the number of 3D objects passing through the at least two wells being equal to the number of the at least two wells and constraining each of the 3D objects passing through the at least two wells to pass through a respective well of the at least two wells. Alternatively, for at least one geological model of the plurality, at least two 3D objects may pass through one of the one or more wells. In that case, the method may further comprise constraining one of the at least two 3D objects to pass through the well. The constraining ensures that at least one backbone passes the well in the models after iterations, which is relevant given that the data does indicate that the lithology at a well is that of the backbone nodes. Moreover, for the objects to preserve the constraining at the wells, the method may ensure that the paired objects pass through the well data for the same node. The paired objects therefore have the same coordinates at this backbone node and thus a zero displacement may preserve the constraining.

In a first situation, several 3D objects may initially pass through a same data (e.g., a same well). In a second situation, several data may be crossed by a same 3D object. The method may apply a different algorithm based on these two situation. In the first situation, the method may choose (e.g., arbitrarily) one of the objects as passing through the data. The method may further comprise removing the conditional status of the other object(s) initially passing through this data, which solves the first situation. In the second situation, the method may duplicate the object passing through several data as many times as the number of data crossed by the object. The method may comprise centering each duplicate of the object on one of the data initially crossed by the object. These different algorithms applied based on the situation are summarized in the FIG. 8. This figure illustrates the obtaining of uniqueness between the number of conditional objects and the number of data. The object “O1” 321 passes through two different data (“P1” 202 and “P2” 203) and is therefore duplicated by the method: “O1” 321 passes through P1 and “O3” 321′ passes through P2. Conversely, “O1” 321 and “O2” 322 both initially pass through “P1” 202. The method comprise removing the conditional status of the object “O2” 322 to keep only one object (“O1” 321) passing through “P1” 202.

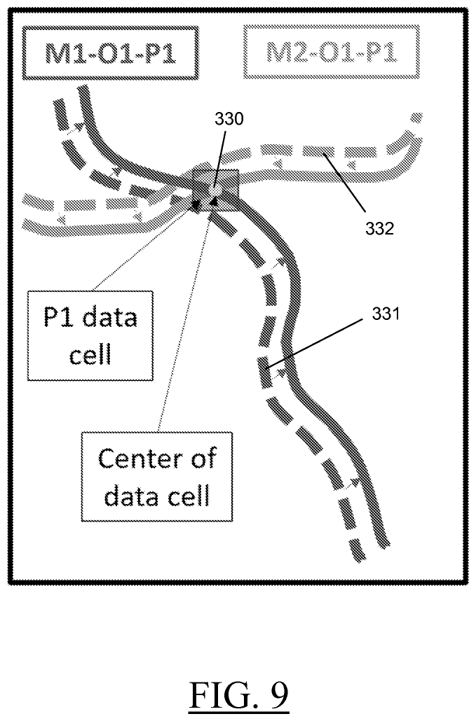

With reference to FIG. 9, the translating of the 3D objects is now discussed in more detail. The centering of the objects allows ensuring that a same node of the object always covers the data. The centering of the objects may be part of the constraining of the 3D objects. The constraining of the respective 3D object to pass through the well may comprise translating the respective 3D object towards a center of the well. The recentering of the backbone nodes of the constrained objects on the data may be done by translating the object towards the center of each data. The translating of the object may comprise translating all the backbone nodes of the object. The translating of the object may comprise translating less the backbone nodes which are more distant from the well than the backbone nodes which are less distant from the well. The method may comprise determining the coordinates X_{d}, Y_{d}, Z_{d} of each data. Thus, by finding the index of the node closest to the data for each object and thus its coordinates Xₖ, Yₖ, Zₖ, the method may comprise computing the translation vector \vec{v}=(Xₖ−X_{d}, Yₖ−Y_{d}, Zₖ−Z_{d}) and move the whole object by this translation. This displacement is shown in the FIG. 9. Object “O1” of model “M1” 331 and object “O1” of model “M2” 332 pass through the same data 330, but the backbone of each object does not pass exactly on the data 330. Each object is therefore translated in such a way as to pass exactly on the data 330.

The translating of objects may have several effects: on the one hand, by translating the objects that were duplicated, the initial proportion of channels in the grid may slightly increase. On the other hand, nothing prevents a translated object from overlapping a matrix data. In the studied problem, only 85% of the matrix data are on average respected after this pairing step. The following implementation details limit these effects.

The translation of the 3D objects may have a component in the three directions X, Y and Z. More than 90% of the matrix data may be violated by this translation because of the Z component. This is related to the fact that the data is distributed at the wells, thus on columns with constant X and Y, and that a simple displacement of the object too low or too high in the column of the well may cause an object to violate matrix data. The method may comprise setting maximum and minimum thicknesses for each constrained object. The translation may comprise translating the constrained object in the area between the set maximum and minimum thicknesses. To avoid the influence of the z-grid resolution on these limits, the method may group the data above each other in a well into clusters. The historical flow data may be divided into the clusters. For each 3D object, the translating of the 3D object may comprise applying a thickness modification to the 3D object with thresholds dependent on sizes of clusters and a grid resolution. The application of the thickness modification allows avoiding overlaying matrix data that should not be in the object.

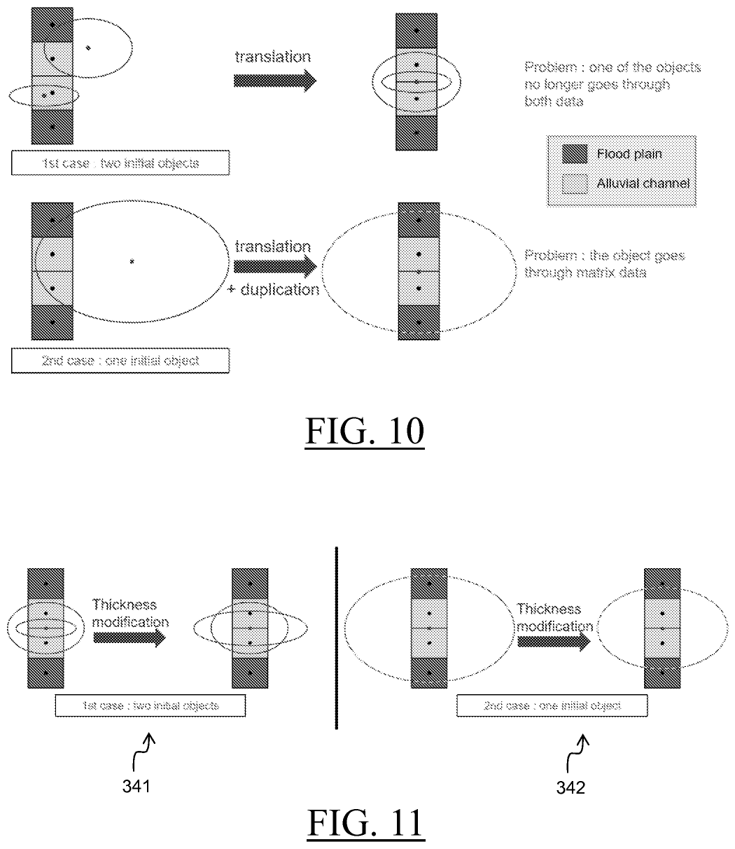

FIGS. 10 and 11 illustrate an example of the applying of the thickness modification. FIG. 10 shows an example of cluster of two data on top of each other, and surrounded above and below by matrix data. Initially, the method may consider two situations: either two objects allow the packing of the two data in the cluster, or a single object passes through both data. In both situations, the method may comprise translating with respect to the average (X,Y,Z) position of the cluster data. Two problems may then arise: in a first case, one or more of the objects, once translated, may no longer pass through any data. In a second case, the object may be too large and may also cross the matrix data above and/or below the cluster. In both cases, the problems are related to exceeding the maximum or minimum allowable thickness of the objects to properly constrain the data. The general formula for the change in thickness to be applied may be as follows:

$${e}_{after} = \{ \begin{matrix}{e}_{before} si {e}_{min} < {e}_{before} < {e}_{max} \\ {e}_{min} si {e}_{before} < {e}_{min} \\ {e}_{max} si {e}_{before} > {e}_{max}\end{matrix}$$

wherein eₘᵢₙ=δz×(N_{cluster}−1)×(1+ϵ) and eₘₐₓ=δz×(N_{cluster}+1)×(1−ϵ). δz is the size of a grid cell in z, N_{cluster} is the size of the data cluster and ϵ is the tolerance on the thickness calculation. ϵ allows for the fact that the backbone position is not quite at the center of the object and dz is not quite constant in the grid. In examples, the tolerance on the thickness calculation may be ϵ=0.05. Such a value for the tolerance on the thickness calculation is a relevant compromise between respected matrix data and respected initial object proportion. The application of this formula on the objects of the FIG. 10 is illustrated in FIG. 11.

FIG. 11 shows the modification of the thickness of objects no longer constraining channel data (“1^{st} case” 341) or constraining matrix data (“2^{nd} case” 342). FIG. 11 shows that the change in thickness applied to the translated objects corrects the problems encountered previously: in the 1^{st} case (341), the object that no longer passed through the channel data has had its thickness increased to pass through it again. In the 2^{nd} case (342), the object that used to overlap matrix data no longer overlaps it. By using these implementations, at the end of the centering of the objects, the method allows respecting 100% of the channel data and 98% of the matrix data on average for an average initial proportion bias over the 100 models of only 0.31%. The translation of the initial constrained objects has therefore almost no impact on the constraining of the initial geological models.

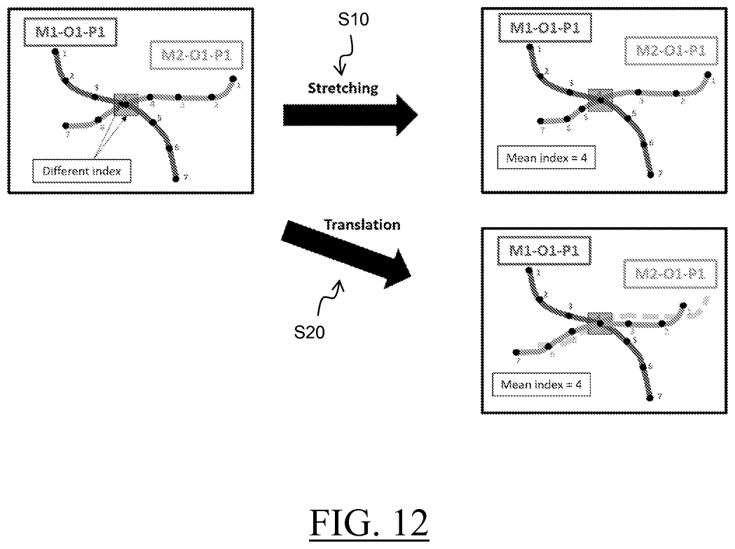

With reference to FIG. 12, the centering of a given backbone node of the set of backbone nodes is now discussed in more detail. The backbones nodes of each object may be numbered. The centering may comprise obtaining a same index for all the backbone nodes of the constrained objects positioned on the data. The centering may comprise centering the given backbone node of the set of backbone nodes of the respective 3D object on the well. The given backbone node may correspond for each respective 3D object constrained to pass through the well (i.e., have the same index for all the constrained objects positioned on the data). The centering allows preserving the constraining. To obtain the same backbone node (i.e., the same node index) positioned on the data on all the constrained objects matched to each other, the method may comprise calculating the index of this backbone node for each model. The method may keep the integer part of the average backbone node of these objects. This average index is usually close to the middle of the objects. The method may then apply one of the following two methods to get the same average index for all objects in all models at the data (or any combination of these two methods). The two methods are illustrated in FIG. 12. The first method S10 (referred to as the “stretching method”) comprises stretching the spacing between backbone nodes so that the index of the backbone node at the data matches the average index across all models. The method may comprise determining the new positions of the backbone nodes by third-order polynomial interpolation. If the starting index was lower than the average index, then the first part of the backbone may decrease in node density and the second part may increase in density. The opposite may occur if the starting index was higher than the average index. The second method S20 (referred to as the “translating method”) comprises translating each object so that the average index node of the object is moved to the data level.

In the example of FIG. 12, two paired objects pass through the same data. One passes through the data at its node 4 while the other passes through the data at its node 5. By taking the integer part of the average index of this node over the two objects, the method may comprise obtaining the index 4. The method may comprise modifying the backbone of the second object so that the current node 4 is shifted to the level of the current node 5 of this object. The two methods discussed above allow obtaining this result.

The method may comprise selecting one of the two methods previously discussed. The selection of the “stretching method” may induce that the loss of node density in part of the 3D objects does not translate into a loss of object resolution The selection of the “stretching method” may induce strong overlaps in the matrix data and a strong change in the initial geometry. The method may verify the quality of the convergence for the implementation, e.g., by simulating production predictions after the performing of the history-Matching.

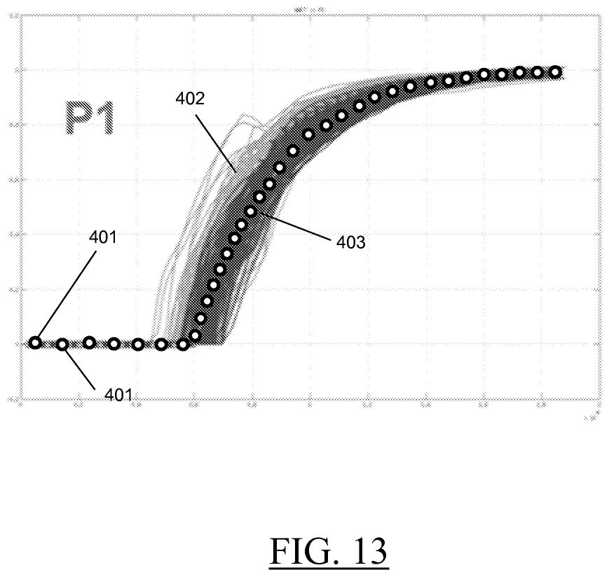

With reference to FIGS. 13 to 19, examples of results of the method are now discussed.

FIGS. 13 to 15 illustrate the results obtained with a first implementation of the method. In this first implementation, all the constrained objects are the same and the pairing algorithm minimizes the distance between the paired objects at the expense of some objects that are deleted. In this first example of results, the convergence of the final set for this implementation over 20 iterations is verified. FIG. 13 shows a plot of the evolution of the dynamic parameters (BHP) for the well “P1” and for the initial geological models 402 (i.e., before the history-matching) and the final geological models (i.e., after the history-matching). Same observations may be made for other dynamic parameters (e.g., OPR or WCT) and the other wells (i.e., P2, P3 or P4). The observation data 401 have an uncertainty. This uncertainty corresponds to the Gaussian noise added to the data: at each implementation, the data values are slightly different. For all the dynamic parameters, the uncertainty on the final geological models is reduced compared to the initial geological models. Moreover, the observation data 401 are always included in the final geological models, and often close to the median of the results of the final geological models. All of this indicates a convergence of the geological models between them.

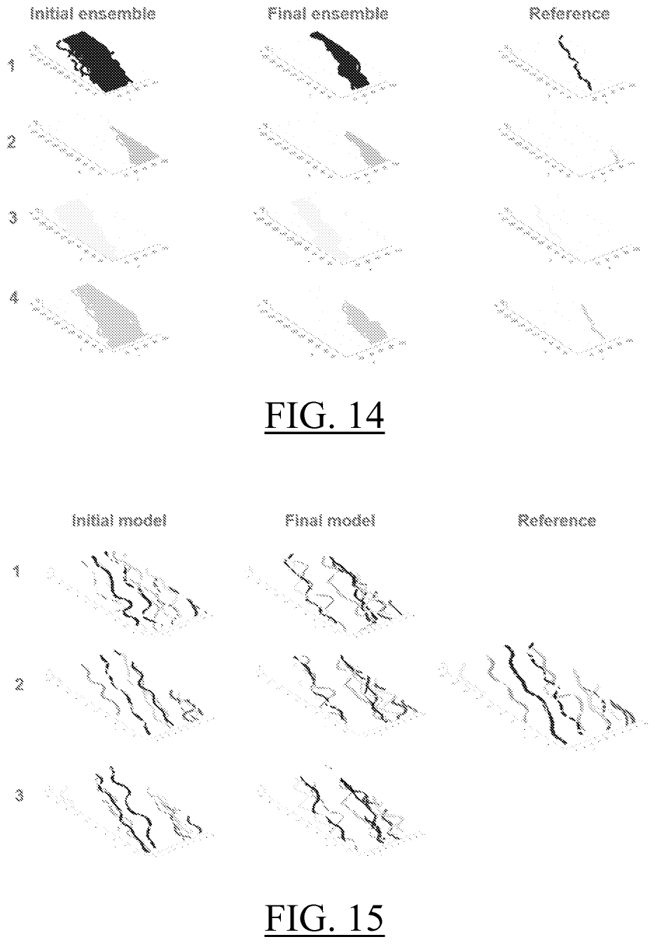

FIG. 14 shows the evolution of the position of objects n°1 to 4 of all geological models placed in the same grid, for the initial geological models and the final geological models after ten iterations. One hundred objects paired between them (one per model) are thus traced in the same grid. Their position is compared to the reference. This evolution confirms the convergence illustrated in FIG. 13. For the four object indices, the positions of the objects tend to converge towards the same position, testifying to the convergence of the static parameters.

FIG. 15 shows a plot of the first ten objects of three models in the initial and final sets. This plot confirm the convergence. Once again, it appears that the ten objects studied converge towards the same position for the three models. On the other hand, these positions do not correspond to those of the reference, testifying again to the non-linearity of the problem.

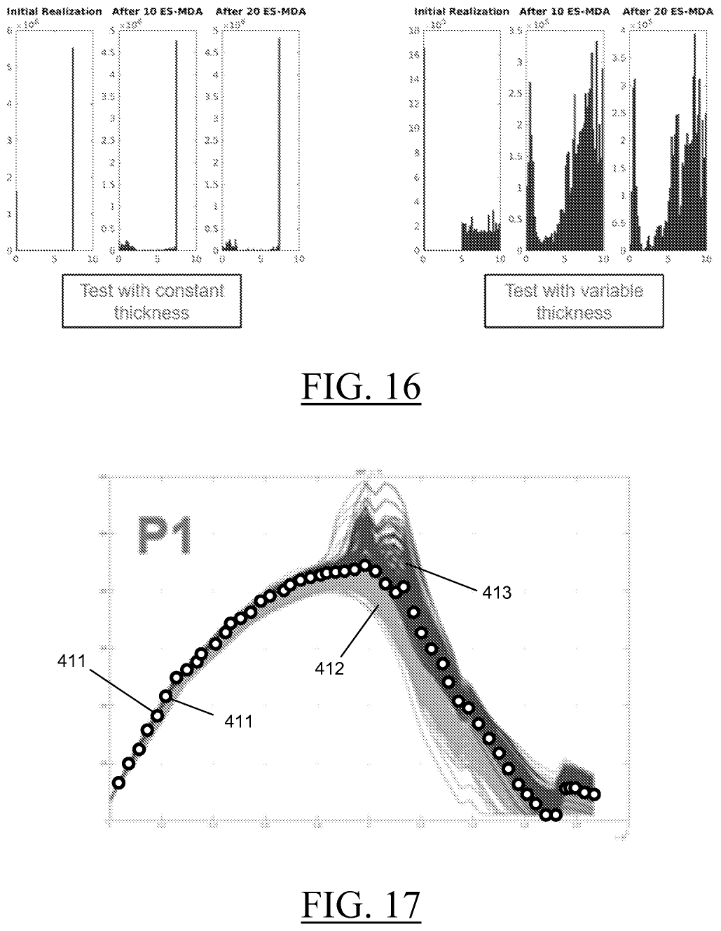

FIGS. 16 and 17 illustrate examples of results obtained with a second implementation of the method. In this second implementation, the copied objects have a thickness fixed at zero. Thus, the initial proportion is still respected. The thickness is added as a variable to be updated by the history-matching. In order to limit the non-linearity of this new variable, the method may not fixe the initial thickness of the objects as constant (the geological variability of the thickness is considered). Finally, to improve the quality of the problem solved with Intersect, the method may implement stepwise production and injection rates in order not to reach minimum pressure at the bottom of each well at the end of the simulation. This simplifies the solved problem in addition to making it more realistic.

To visualize the effect of thickness nonlinearity on the inversion, histograms of object thicknesses are plotted for two cases: a case with constant initial thickness at 7.5 m and a case with uniform initial thickness between 5 and 10 m (see FIG. 16). The two initial histograms clearly show the presence of the copied objects with zero thickness, again representing about a quarter of the total initial objects. The zero thickness objects sometimes increase in thickness, giving flexibility to the problem solving. The footprint of objects in the grid may be changed gradually: an object initially 7.5 m thick may decrease in thickness if it does not contribute much to the convergence. Increasing the grid resolution in z also limits the resolution effects of the grid on thin objects, which will lose less continuity.

FIG. 17 shows the evolution of the BHP parameter for the well “P1”. In particular, the FIG. 17 shows the evolution of the BHP parameter for the initial geological models (413), the final geological models (413) and the observation data (411). The figure shows the increase in the convergence quality. Firstly, both the reference and the final set no longer or almost no longer reach the minimum pressure for the well “P1”. This facilitates the convergence of the ensemble to the observation data. As in the first implementation, the uncertainty in the final geological models has been largely reduced compared to the initial geological models, to an even greater extent than in the first implementation. The same observations may be made for each of the other well “P2”, “P3”, “P4” and “I1”.

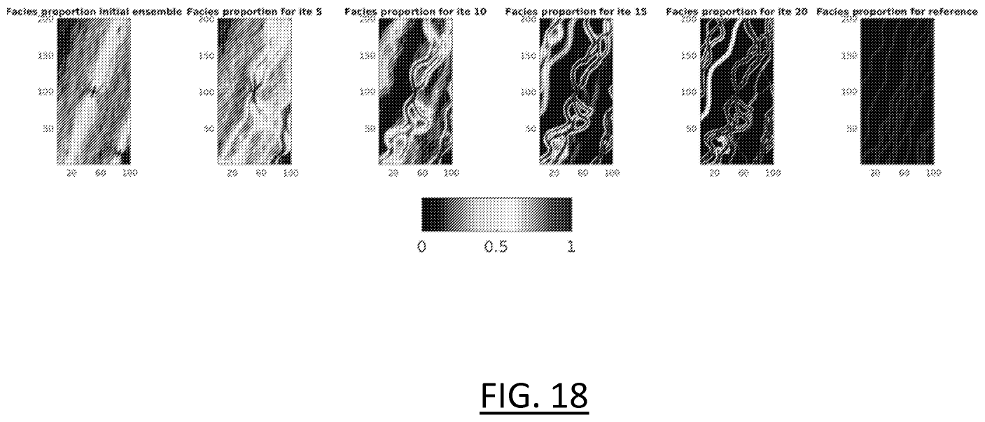

FIG. 18 illustrates examples of results obtained with a third implementation of the method. In particular, FIG. 18 shows channel probability maps of the layer “9” of the grid for different numbers of iterations and comparison with the reference. The third implementation incorporates the algorithm to preserve the initial constrained objects in each model during the pairing. The constrained objects may move during the data assimilation, their only static nodes may be the ones that actually pass through conditional data. This can be visualized by plotting the probability maps of one of the grid layers as the assimilation iterations proceed (see FIG. 18). For the initial geological models, the channel probability is close to 1 at the conditional data, and about 0.5 along the axes of the constrained objects. Throughout the rest of the domain, the probability is around 0 to 0.1. As the iterations go on, the path of the channels, conditional or not, becomes clearer, to reach a probability close to 1 on most of the channels after 20 iterations. The third implementation therefore improves the convergence of the different models.

In examples, spurious correlations may appear, linked to the limited size N of the ensemble. Indeed, the approximation made to the error covariance matrix has difficulty in reproducing the zero values of the real covariance matrix, which increases the risk of updating parameters that are far from the observation data, even if these parameters are not correlated with the data because of this distance. Over time, these false correlations increase the risk of an underestimation of the uncertainty. To limit this effect, the updating may comprise performing a distance-based localization (referred to as “DB localization”), thereby ignoring one or more 3D objects positioned at a distance greater than a threshold from each of the at least one well.

The general idea of the localization is to use only a subset of the state variables during the assimilation of each observation data. It therefore corresponds to a reduction in the dimension of the assimilation step.

In examples, the DB localization (or “covariance localization”) comprises modifying the augmented covariance matrix

$${C}_{X , h}^{f}$$

and thus the Kalman gain. Each element of

$${C}_{X , h}^{f}$$

is multiplied by a distance-dependent correlation function (also referred to as “localization function”), varying from 1 to 0 at predefined radial distances. Examples of localization function include a fifth-order polynomial function of Gaussian form with compact support. The new Kalman gain formula becomes:

$${K}_{h} = ( ρ° {C}_{X , h}^{f} ) {( ρ° {C}_{X , h}^{f} + {R}_{h} )}^{- 1}$$

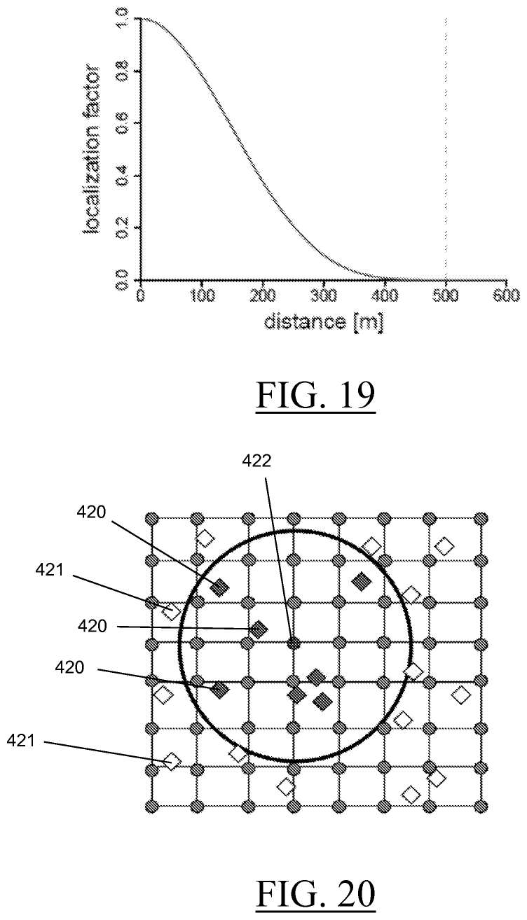

with ρ the localization matrix and ° the element by element multiplication or Schur product. FIG. 19 shows an example of the localization function.

In examples, the updating may comprise performing a local analysis, where, at each assimilation step, the parameters are processed group by group according to their location. For each group, only the observation data at a distance d from this group are used for the assimilation. The choice of this distance is quite complex and depends on the problem because if d is too large, “false correlations” are not removed, but if d is too small, domains that should be updated are not. This local analysis is illustrated in FIG. 20. The figure shows, among all the observations (square-shaped points 420, 421), the observations 420 that are close enough to the observation data 422, and that are used in the assimilation.

In the framework of the object based inverse problem, a risk of collapses has been observed and may be a sign of a problem where the final uncertainty is underestimated, since the problem is non-linear. This means that a phenomenon of “false correlations” appears in the Kalman gain approximation.

The inherent difficulty in localizing object models is that it is difficult to apply a variable localization criterion on the same object, at the risk of distorting it unevenly. Thus, in examples wherein the DB localization is performed, the method may comprise selecting the size and shape of the localization area.

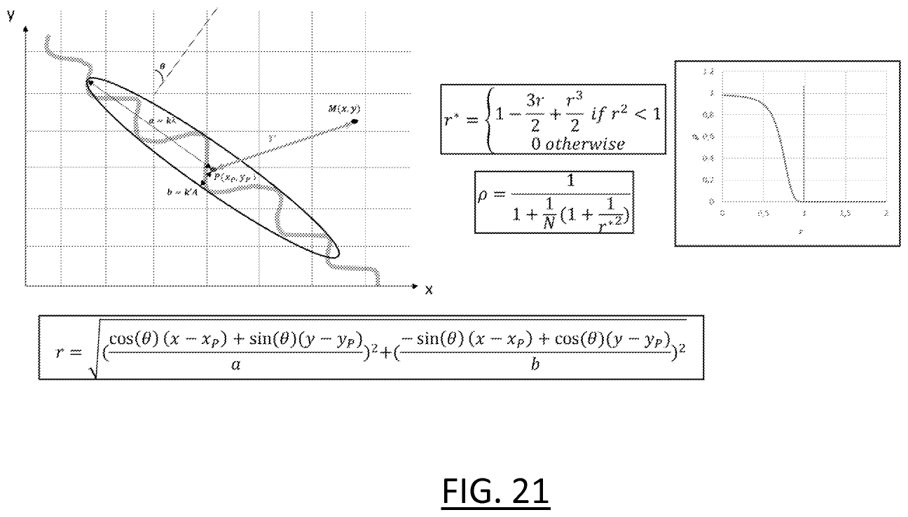

An example of the distance-based localization is now discussed in reference to FIG. 21. In this example, the method comprises preserving conditional object and the updating comprises performing the DB localization. The covariance localization function is configured to take an ellipsoidal shape, in the azimuth direction θ of the objects. The ellipsoidal shape may be of half major axis length a proportional to the wavelength λ of the channels and of half minor axis length b proportional to their amplitude A. The form of this localization function is shown in FIG. 21. The figure shows the localization in the form of an ellipse. The method comprises computing a normalized distance criterion r, and, then, depending on whether M is in or out of the ellipse, computing a covariance function ρ in this normalized space of the ellipse. On the right of the figure is plotted the function ρ=f(r). The method works for substantially vertical wells or not (e.g., by considering horizontal segments of wells. The method is also suitable for objects of substantially relatively constant azimuth and sinusoidal shape or not (e.g., by using a simple cylindrical location). The point P(xₚ, yₚ) corresponds to the coordinates of the well P. Each node of each object of average position on the set is traversed in (x, y). Each time, a normalized distance r is computed with the well, which depends on the lengths of the minor and major axes a and b. The criterion for whether a node is inside or outside the ellipse is r²<1. A corrected radius r* is then computed according to whether the node belongs to the ellipse or not. If the node is in the ellipse, the corrected radius is a polynomial of order 3. Otherwise, the corrected radius takes a null value. The covariance location p is then computed for the cell under consideration by normalizing between 0 and 1 the value of r*, also with a dependence on the size of the set N.

In examples, a may be equal to k×5000 m with k in a range of 1 to 4, b may be equal to k′×995 m with k′ in a range of 1 to 4, and 0 may be equal to 32.5° (i.e., 90° minus the azimuth of the channels, as North may be defined relative to the y-axis in the model). The grid size may be 20000 [m]×10000 [m] in total, and considering that the channels start roughly diagonal to the axes of the grid, the domain diagonal may be 22360 m, and thus at most four to five channel oscillations may be placed there, hence the interest in varying k between 1 and 4 in the formula for a to find the best compromise. Indeed, if a is too small, too little data is updated and there is a risk that the convergence is very slow. On the contrary, if a is too large, there is a risk that the localization is useless because almost all objects is updated by the wells.

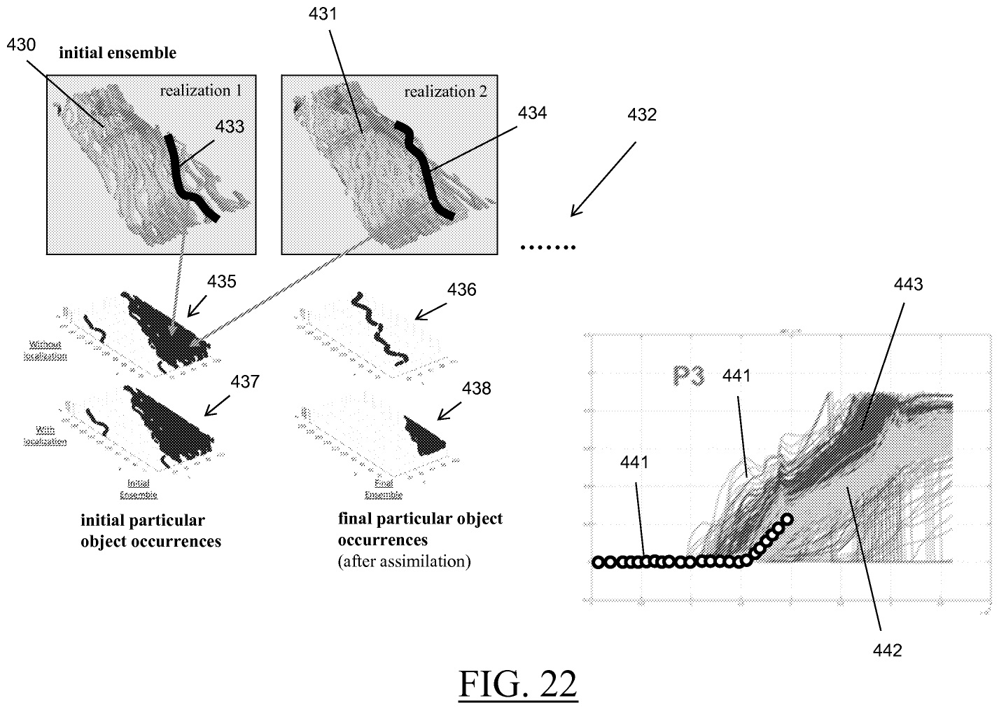

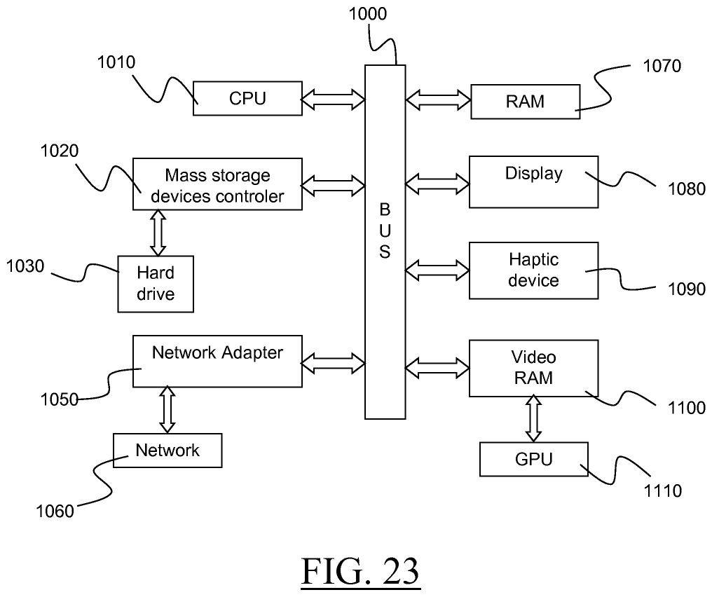

FIG. 22 illustrates results of the method with and without the localization. The figure shows two initial models 430, 431, and for each model, a respective 3D object (433 for the model 430 and 434 for the model 431). The 3D objects 433 and 434 are paired together, and also with other 3D objects of other models 432 (illustrated by the “ . . . ”). The figure shows the results with the localization (initial ensemble 435 and final ensemble 436) and without the localization (initial ensemble 437 and final ensemble 438). The initial ensemble (435 or 437) is the ensemble of 3D objects paired together with the 3D objects 433 and 434, i.e., the ensemble comprising the 3D objects 433 and 434 for the models 430, 431 and also the other 3D objects paired with these 3D objects 433 and 434 of other models 432. The figure shows that, without localization, the 3D objects are collapsed in the final ensemble 436. The phenomenon of “false correlations” appears in the Kalman gain approximation and there is therefore a risk that the final uncertainty is underestimated. On the contrary, with the localization, the ensemble 438 retains variability and the convergence does not induce a collapse of the objects (the localization avoids the collapse), which reduces the risk of underestimating the final uncertainty, and thus improves the results. The figure also shows a graph with the results including the historical data 441, the results 442 with the initial ensemble 441, the results 443 with the final ensemble 436 without localization and the results with the final ensemble 438 with localization. The results shows that the results with the localization are more scattered than the results 442 without the localization, and that the localization therefore allows avoiding the underestimating of the final uncertainty by avoiding the collapse of the 3D objects of the models.

The method is computer-implemented. This means that steps (or substantially all the steps) of the method are executed by at least one computer, or any system alike. Thus, steps of the method are performed by the computer, possibly fully automatically, or, semi-automatically. In examples, the triggering of at least some of the steps of the method may be performed through user-computer interaction. The level of user-computer interaction required may depend on the level of automatism foreseen and put in balance with the need to implement user's wishes. In examples, this level may be user-defined and/or pre-defined.

A typical example of computer-implementation of a method is to perform the method with a system adapted for this purpose. The system may comprise a processor coupled to a memory and a graphical user interface (GUI), the memory having recorded thereon a computer program comprising instructions for performing the method. The memory may also store a database. The memory is any hardware adapted for such storage, possibly comprising several physical distinct parts (e.g. one for the program, and possibly one for the database).

FIG. 23 shows an example of the system, wherein the system is a client computer system, e.g. a workstation of a user.

The client computer of the example comprises a central processing unit (CPU) 1010 connected to an internal communication BUS 1000, a random access memory (RAM) 1070 also connected to the BUS. The client computer is further provided with a graphical processing unit (GPU) 1110 which is associated with a video random access memory 1100 connected to the BUS. Video RAM 1100 is also known in the art as frame buffer. A mass storage device controller 1020 manages accesses to a mass memory device, such as hard drive 1030. Mass memory devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks. Any of the foregoing may be supplemented by, or incorporated in, specially designed ASICs (application-specific integrated circuits). A network adapter 1050 manages accesses to a network 1060. The client computer may also include a haptic device 1090 such as cursor control device, a keyboard or the like. A cursor control device is used in the client computer to permit the user to selectively position a cursor at any desired location on display 1080. In addition, the cursor control device allows the user to select various commands, and input control signals. The cursor control device includes a number of signal generation devices for input control signals to system. Typically, a cursor control device may be a mouse, the button of the mouse being used to generate the signals. Alternatively or additionally, the client computer system may comprise a sensitive pad, and/or a sensitive screen.

The computer program may comprise instructions executable by a computer, the instructions comprising means for causing the above system to perform the method. The program may be recordable on any data storage medium, including the memory of the system. The program may for example be implemented in digital electronic circuitry, or in computer hardware, firmware, software, or in combinations of them. The program may be implemented as an apparatus, for example a product tangibly embodied in a machine-readable storage device for execution by a programmable processor. Method steps may be performed by a programmable processor executing a program of instructions to perform functions of the method by operating on input data and generating output. The processor may thus be programmable and coupled to receive data and instructions from, and to transmit data and instructions to, a data storage system, at least one input device, and at least one output device. The application program may be implemented in a high-level procedural or object-oriented programming language, or in assembly or machine language if desired. In any case, the language may be a compiled or interpreted language. The program may be a full installation program or an update program. Application of the program on the system results in any case in instructions for performing the method. The computer program may alternatively be stored and executed on a server of a cloud computing environment, the server being in communication across a network with one or more clients. In such a case a processing unit executes the instructions comprised by the program, thereby causing the method to be performed on the cloud computing environment.

1. A computer-implemented method of geomodelling with respect to a subsoil having one or more wells, the method comprising:
providing, for at least one well, respective historical flow data;
providing a plurality of geological models each representing the subsoil, each geological model comprising:
a respective gridding comprising cells,
a respective cell-wise distribution of porosity values and a respective cell-wise distribution of permeability values, and
respective 3D objects each representing a respective lithology, each 3D object being specified at least by respective positioning values;
providing a flow simulator;
providing a pairing between the 3D objects across the geological models;
performing history-matching to calibrate the plurality of geological models on the historical flow data based on the respective cell-wise distribution of porosity values, the respective cell-wise distribution of permeability values, the respective positioning values of each respective 3D object, the flow simulator and the pairing.

2. The method of claim 1, wherein the history-matching includes iteratively, for each geological model:
determining a cell-wise distribution of lithology values based on the respective positioning values of the respective 3D objects;
inputting to the flow simulator the cell-wise distribution of porosity values, the cell-wise distribution of permeability values, and the determined cell-wise distribution of lithology values, so as to calculate respective virtual flow data corresponding to the respective historical flow data of each of the at least one well;
for each of the at least one well, computing a respective error between the respective virtual flow data and the respective historical flow data;
based on the pairing and on each respective error, inverting the respective cell-wise distribution of porosity values, the respective cell-wise distribution of permeability values, and the respective positioning values of each respective 3D object.

3. The method of claim 2, wherein each 3D object is specified by a respective set of backbone nodes, the respective positioning values specifying each 3D object including respective coordinates of each backbone node.

4. The method of claim 3, wherein each 3D object is further specified by, for each backbone node, a respective cross-section, the set of backbone nodes and the respective cross-sections delimiting, for each 3D object, a respective volume of the 3D object, the determining of the cell-wise distribution of lithology values comprising, for each cell of the respective gridding:
determining whether a center of the cell is inside the respective volume of one of the respective 3D objects; and
selecting, for the cell, a first lithology value when the center of the cell is inside the respective volume, or a second lithology value when the center of the cell is not inside the respective volume.

5. The method of claim 4, wherein each respective cross-section is convex and has a thickness and a width, the respective positioning values specifying each 3D object further including the thickness and the width of each respective cross-section.

6. The method of claim 2, wherein the inverting is based on an ensemble Kalman filter approach based on a state vector, the state vector including the respective cell-wise distribution of porosity values, the respective cell-wise distribution of permeability values and the respective positioning values of each respective 3D object, the inverting of the respective positioning values of each respective 3D object comprising updating the state vector based on:
a covariance matrix between the respective virtual flow data and the state vector,
a variance matrix in the respective virtual flow data,
an error matrix of the respective historical flow data, and
a difference between the respective historical flow data and the respective virtual flow data.

7. The method of claim 6, wherein the updating comprises performing a distance-based localization, thereby ignoring one or more 3D objects positioned at a distance greater than a threshold from each of the at least one well.

8. The method of claim 1, wherein at least one first geological model of the plurality has a first number of respective 3D objects and at least one second geological model of the plurality has a second number of respective 3D objects, the first number being lower than the second number, the method further comprising adding one or more 3D objects to each of the at least one first geological model, the number of the added one or more 3D objects being equal to the difference between the second number and the first number.

9. The method of claim 8, wherein a thickness of each respective cross-section of each of the added one or more 3D objects is zero.

10. The method of claim 1, the method further comprising, for each geological model and each well, constraining a respective 3D object to pass through the well, the pairing comprising pairing the respective 3D objects of the geological models constrained to pass through a same well,
wherein optionally the constraining of the respective 3D object to pass through the well comprises translating the respective 3D object towards a center of the well.

11. The method of claim 10, wherein the constraining of the respective 3D object to pass through the well comprises translating the respective 3D object towards a center of the well, the historical flow data being divided into clusters, and the translating of the respective 3D object comprising applying a thickness modification to the respective 3D object with thresholds dependent on sizes of clusters and a grid resolution.

12. The method of claim 10, wherein the constraining of the respective 3D object to pass through the well comprises translating the respective 3D object towards a center of the well, the backbone nodes of each constrained 3D objects being numbered, the translating of the respective 3D object comprising centering a given backbone node of the set of backbone nodes of the respective 3D object on the well, the number of the given backbone node being, for each well, the same for each respective 3D object constrained to pass through the well.

13. (canceled)

14. A non-transitory computer readable storage medium having recorded thereon a computer program comprising instructions for performing a method of geomodelling with respect to a subsoil having one or more wells, the method comprising:
providing, for at least one well, respective historical flow data;
providing a plurality of geological models each representing the subsoil, each geological model comprising:
a respective gridding comprising cells,
a respective cell-wise distribution of porosity values and a respective cell-wise distribution of permeability values, and
respective 3D objects each representing a respective lithology, each 3D object being specified at least by respective positioning values;
providing a flow simulator;
providing a pairing between the 3D objects across the geological models;
performing history-matching to calibrate the plurality of geological models on the historical flow data based on the respective cell-wise distribution of porosity values, the respective cell-wise distribution of permeability values, the respective positioning values of each respective 3D object, the flow simulator and the pairing.

15. A system comprising a processor coupled to a memory and a graphical user interface, the memory having recorded thereon a computer program comprising instructions for performing a method of geomodelling with respect to a subsoil having one or more wells, the method comprising:
providing, for at least one well, respective historical flow data;
providing a plurality of geological models each representing the subsoil, each geological model comprising:
a respective gridding comprising cells,
a respective cell-wise distribution of porosity values and a respective cell-wise distribution of permeability values, and
respective 3D objects each representing a respective lithology, each 3D object being specified at least by respective positioning values;
providing a flow simulator;
providing a pairing between the 3D objects across the geological models;
performing history-matching to calibrate the plurality of geological models on the historical flow data based on the respective cell-wise distribution of porosity values, the respective cell-wise distribution of permeability values, the respective positioning values of each respective 3D object, the flow simulator and the pairing.

16. The method of claim 15, wherein the history-matching includes iteratively, for each geological model:
determining a cell-wise distribution of lithology values based on the respective positioning values of the respective 3D objects;
inputting to the flow simulator the cell-wise distribution of porosity values, the cell-wise distribution of permeability values, and the determined cell-wise distribution of lithology values, so as to calculate respective virtual flow data corresponding to the respective historical flow data of each of the at least one well;
for each of the at least one well, computing a respective error between the respective virtual flow data and the respective historical flow data;
based on the pairing and on each respective error, inverting the respective cell-wise distribution of porosity values, the respective cell-wise distribution of permeability values, and the respective positioning values of each respective 3D object.

17. The method of claim 16, wherein each 3D object is specified by a respective set of backbone nodes, the respective positioning values specifying each 3D object including respective coordinates of each backbone node.

18. The method of claim 17, wherein each 3D object is further specified by, for each backbone node, a respective cross-section, the set of backbone nodes and the respective cross-sections delimiting, for each 3D object, a respective volume of the 3D object, the determining of the cell-wise distribution of lithology values comprising, for each cell of the respective gridding:
determining whether a center of the cell is inside the respective volume of one of the respective 3D objects; and
selecting, for the cell, a first lithology value when the center of the cell is inside the respective volume, or a second lithology value when the center of the cell is not inside the respective volume.

19. The method of claim 14, wherein the history-matching includes iteratively, for each geological model:
determining a cell-wise distribution of lithology values based on the respective positioning values of the respective 3D objects;
inputting to the flow simulator the cell-wise distribution of porosity values, the cell-wise distribution of permeability values, and the determined cell-wise distribution of lithology values, so as to calculate respective virtual flow data corresponding to the respective historical flow data of each of the at least one well;
for each of the at least one well, computing a respective error between the respective virtual flow data and the respective historical flow data;
based on the pairing and on each respective error, inverting the respective cell-wise distribution of porosity values, the respective cell-wise distribution of permeability values, and the respective positioning values of each respective 3D object.

20. The method of claim 19, wherein each 3D object is specified by a respective set of backbone nodes, the respective positioning values specifying each 3D object including respective coordinates of each backbone node.

21. The method of claim 20, wherein each 3D object is further specified by, for each backbone node, a respective cross-section, the set of backbone nodes and the respective cross-sections delimiting, for each 3D object, a respective volume of the 3D object, the determining of the cell-wise distribution of lithology values comprising, for each cell of the respective gridding:
determining whether a center of the cell is inside the respective volume of one of the respective 3D objects; and
selecting, for the cell, a first lithology value when the center of the cell is inside the respective volume, or a second lithology value when the center of the cell is not inside the respective volume.
